(19) United States
(12) Patent Application Publication
(10) Pub. No.: US 2025/0175814 A1
(43) Pub. Date: May 29, 2025

(54) MANAGING RADIO RESOURCE CONFIGURATIONS FOR SMALL DATA COMMUNICATION

(71) Applicant: GOOGLE LLC, Mountain View, CA (US)

(72) Inventor: Chih-Hsiang Wu, Taoyuan City (TW)

(21) Appl. No.: 18/726,962

(22) PCT Filed: Jan. 6, 2023
(86) PCT No.: PCT/US23/10285

§ 371 Date: Jul. 5, 2024

Related U.S. Application Data
(60) Provisional application No. 63/341,740, filed on May 13, 2022.
(60) Provisional application No. 63/297,228, filed on Jan. 6, 2022.

(51) Int. Cl. H04W 24/02; H04W 24/08; H04W 76/20

(52) U.S. Cl. CPC H04W 24/02; H04W 24/08; H04W 76/20

(57) ABSTRACT

In a method of handling small data transmission (SDT) with a user equipment (UE), a DU communicates (318 or 418) with the UE in accordance with a first DU configuration. While communicating with the UE in accordance with the first DU configuration, the DU determines that there is data inactivity of the UE. The DU transmits an indication of UE data inactivity to the CU (322 or 422). After transmitting the indication, the DU receives (328 or 428), from the CU, a CU-to-DU message requesting a SDT DU configuration for the UE, and transmits (332 and 334, or 432 and 434) a SDT DU configuration to the UE.

### FIELD OF THE DISCLOSURE

This disclosure relates generally to wireless communications and, more particularly, to communication of uplink and/or downlink data at a user equipment (UE) and a distributed unit (DU) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating in a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state using RAN-level base station coordination and RAN-level paging procedures. In some cases, the UE in the RRC_INACTIVE state has only one, relatively small packet to transmit. For situations such as these, 3GPP is discussing a Small Data Transmission (SDT) procedure to enable the 5G NR to support data transmission for the UE operating in the RRC_INACTIVE state (i.e., without requiring that the UE transition to the RRC_CONNECTED state).

SDT is enabled on a radio bearer basis and is initiated by the UE only if less than a configured amount of uplink data awaits transmission across all radio bearers for which SDT is enabled, the downlink (DL) reference signal received power (RSRP) is above a configured threshold, and a valid SDT resource is available. A SDT procedure can be initiated by the UE with either a transmission over a random access channel (RACH), i.e., random access SDT (RA-SDT), or over Type 1 configured grant (CG) resources, i.e., CG-SDT. For the RA-SDT, the network configures 2-step and/or 4-step random access resources for SDT. In the RA-SDT, the UE can transmit an initial transmission including data in a message 3 (MSG3) of a 4-step random access procedure or in payload of a message A (MSGA) of a 2-step random access procedure. The network can then schedule subsequent uplink and/or downlink transmissions using dynamic uplink grants and downlink assignments, respectively, after completion of the random access procedure.

The CG-SDT can only be initiated with valid uplink (UL) timing alignment. The UL timing alignment is maintained by the UE based on a network-configured, SDT-specific timing alignment timer and DL RSRP of a configured number of highest ranked SSBs. Upon expiry of the SDT-specific timing alignment timer, the CG resources are released. Upon initiating the CG-SDT, the UE transmits an initial transmission including data on a CG occasion using a CG configuration, and the network can schedule subsequent uplink transmissions using dynamic grants or on future CG resource occasions. During the CG-SDT, the downlink transmissions are scheduled using dynamic assignments. The UE can initiate subsequent uplink transmission only after receiving, from the network, confirmation for the initial uplink transmission.

In some scenarios, the UE may connect to a 5G NR radio access network (NG-RAN) that includes base stations each having a central unit (CU) and at least one distributed unit (DU). However, it is not clear how a base station including a CU and a DU should configure the UE with SDT configuration parameters to enable RA-SDT or CG-SDT.

### SUMMARY

According to certain techniques of this disclosure, a CU of a base station can determine to configure or reconfigure a UE for SDT operation, e.g., when the UE is connected to the RAN and has been communicating in non-SDT operation with the base station via a DU, or when the UE is in an inactive state and has already been communicating in SDT operation with the base station via a DU. In either scenario, the CU then requests a SDT DU configuration by sending a CU-to-DU message (e.g., a UE Context Modification Request message) to a DU that is in communication with the UE, and the DU responds by sending a DU-to-CU message (e.g., a UE Context Modification Response message) that includes the SDT DU configuration. The CU then sends the DU another CU-to-DU message that includes both the SDT DU configuration and a SDT CU configuration, and the DU forwards the SDT DU configuration and SDT CU configuration to the UE. For example, the DU may send the SDT configurations to the UE in an RRC release message.

In some implementations, the CU determines to configure or reconfigure the UE for SDT operation in response to an indication of UE data inactivity (e.g., for at least some threshold period of time). For example, a user plane of the CU (CU-UP) may monitor the data activity of the UE, and inform a control plane of the CU (CU-CP) when the CU-UP detects data inactivity for the UE. As another example, the DU may monitor the data activity of the UE (e.g., in response to the CU instructing the DU to monitor for UE data inactivity), and send an inactivity notification to the CU when the DU detects data inactivity for the UE. As yet another example, the UE may monitor its own data activity, and send the DU UE assistance information including an inactivity indicator when the UE detects data inactivity. The DU may then send the CU a UL RRC Message Transfer message including the UE assistance information.

In some implementations, the CU does not request a SDT DU configuration when the CU determines to configure or reconfigure the UE for SDT operation. For example, the CU may instead autonomously generate a SDT configuration (including a SDT CU configuration and possibly also a SDT DU configuration), and send the SDT configuration to the UE (via the DU) without first receiving any SDT configuration parameters from the DU.

In some implementations, the UE generally uses a SDT configuration from the base station during SDT operation, but uses other configuration parameters (e.g., non-SDT and/or default configuration parameters) to perform one or more functions for which the SDT configuration does not include suitable parameters. The function(s) may be MAC-level functions such as buffer status report (BSR) and/or power headroom report (PHR) functions, for example. Moreover, in some implementations, the UE can inform the RAN of its preferences (e.g., make requests) relating to SDT operation. For example, the UE may send a base station a request or preference to be in the inactive state with SDT configured, a request or preference to be in the inactive state without SDT configured, a request or preference for SDT to stop, and so on.

As used herein, and unless a more specific meaning is clear from the context of use, the term “data” or “data packet” can refer to signaling, control-plane information at a protocol layer of controlling radio resources (e.g., RRC), controlling mobility management (MM), or controlling session management (SM), or can refer to non-signaling, non-control-plane information at a protocol layer above the layer of the protocol for controlling radio resources (e.g., RRC), above the layer of the protocol for controlling Packet Data Convergence Protocol (PDCP), above the layer of the protocol for controlling MM, above the layer of the protocol for controlling SM, and/or above the layer of the protocol for controlling quality of service (QOS) flows (e.g., service data adaptation protocol (SDAP)). The data to which the UE and/or the RAN applies the techniques of this disclosure can include, for example, Internet of things (IOT) data, Ethernet traffic data, Internet traffic data, or a short message service (SMS) message, for example. Further, the UE in some implementations applies SDT techniques only if the size of the data is below a certain (e.g., configured) threshold value. It is also understood that, as used herein (and unless the context of its use indicates a more specific meaning), the term “configuration” can refer to a full configuration, or to a subset of parameters of a full configuration (e.g., a “delta” or other partial configuration that can augment an existing configuration without completely replacing the existing configuration).

In one example, a method of handling SDT with a UE is implemented by a DU of a base station that also includes a CU. The method includes communicating with the UE in accordance with a first DU configuration and, while communicating with the UE in accordance with the first DU configuration, determining that there is data inactivity of the UE. The method also includes transmitting an indication of UE data inactivity to the CU and, after transmitting the indication, receiving from the CU a CU-to-DU message requesting a SDT DU configuration for the UE. The method also includes transmitting a SDT DU configuration to the UE.

In another example, a method of handling SDT with a UE is implemented by a CU of a base station that also includes a DU. The method includes communicating with the UE via the DU and in accordance with a first CU configuration and, while communicating with the UE via the DU in accordance with the first CU configuration, determining, by a user plane of the CU (CU-UP), that there is data inactivity of the UE. The method also includes transmitting an indication of UE data inactivity to a control plane of the CU (CU-CP) and, after transmitting the indication, transmitting to the DU a CU-to-DU message requesting a SDT DU configuration for the UE. The method also includes receiving a DU-to-CU message including the SDT DU configuration from the DU.

In another example, a RAN node includes processing hardware and is configured to perform any one of the methods described above.

### BRIEF DESCRIPTION OF THE DRAWINGS

FIG. 1A is a block diagram of an example wireless communication system in which a user device and a base station of this disclosure can implement the techniques of this disclosure for reducing latency in data communication;

FIG. 1B is a block diagram of an example base station in which a centralized unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3 is a messaging diagram of an example procedure for obtaining a non-SDT configuration for communicating data packets between a UE and a distributed base station when a radio connection between the UE and the base station is active, and for obtaining a SDT configuration for communicating data packets between the UE and the distributed base station when the radio connection between the UE and the base station is inactive;

FIG. 4 is a messaging diagram of an example procedure for communicating data packets between a UE and a distributed base station when a radio connection between the UE and the base station is inactive;

FIG. 5 is a flow diagram of an example method, which can be implemented in the DU of FIG. 1B, for providing SDT configuration parameters to a UE via a CU;

FIG. 6 is a flow diagram of an example method, which can be implemented in the CU or CU-CP of FIG. 1B, for providing SDT configuration parameters to a UE;

FIG. 7 is a flow diagram of an example method, which can be implemented in the CU of FIG. 1B, for obtaining SDT configuration parameters for a UE from a DU;

FIG. 8 is a flow diagram of an example method, which can be implemented in the CU of FIG. 1B, for determining to transmit a message including a DU configuration to a UE;

FIG. 9 is a flow diagram of an example method, which can be implemented in the DU of FIG. 1B, for providing a SDT DU configuration or a non-SDT DU configuration for a UE to a CU;

FIG. 10 is a flow diagram of an example method, which can be implemented in the CU of FIG. 1B, for determining whether to perform a CU-DU procedure for data communication with a UE, and determining to transmit a message including a configuration for the data communication with the UE;

FIG. 11 is a flow diagram of an example method, which can be implemented in the CU of FIG. 1B, for configuring SDT for a UE;

FIG. 12 is a flow diagram of an example method, which can be implemented in the CU-CP of FIG. 1B, for configuring SDT for a UE;

FIG. 13 is a flow diagram of an example method, which can be implemented in the CU or CU-CP of FIG. 1B, for configuring data activity monitoring for a UE;

FIGS. 14-15 is a flow diagram of an example method, which can be implemented in the UE of FIG. 1A, for stopping SDT with a RAN;

FIG. 16 is a flow diagram of an example method, which can be implemented in the UE of FIG. 1A, for performing SDT with a RAN.

### DETAILED DESCRIPTION OF THE DRAWINGS

As discussed in more detail below, a user equipment (UE) and/or a network node of a radio access network (RAN) can use the techniques of this disclosure for managing small data communication and transitioning a UE between states of a protocol for controlling radio resources between the UE and the RAN. As used in this disclosure, small data communication can refer to small data transmission (SDT) from the perspective of the network (i.e., SDT in the downlink direction), or SDT from the perspective of the UE (i.e., SDT in the uplink direction).

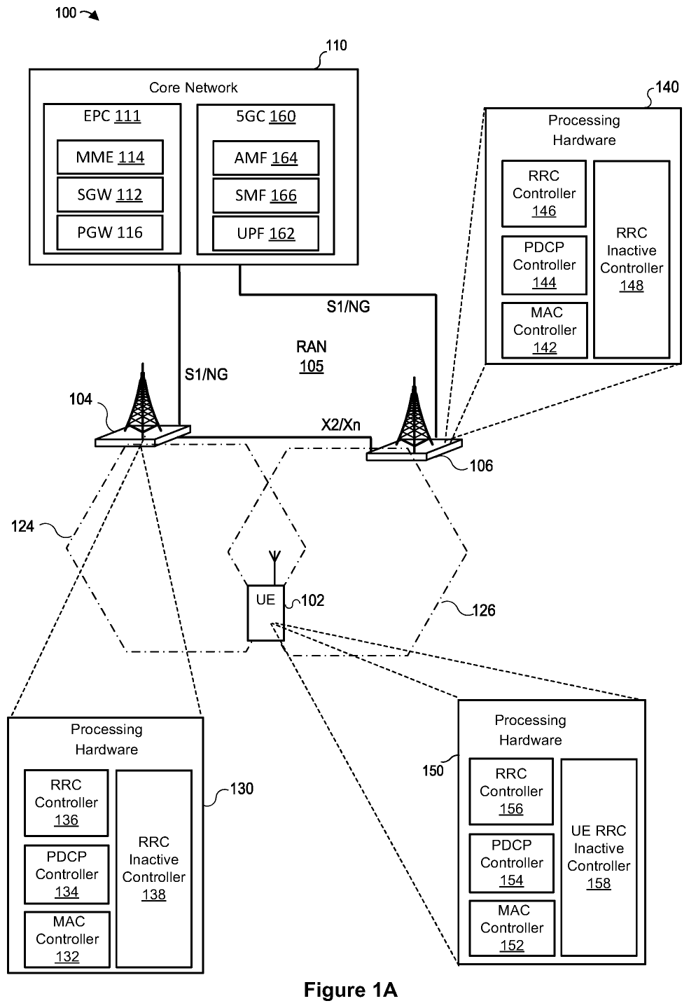

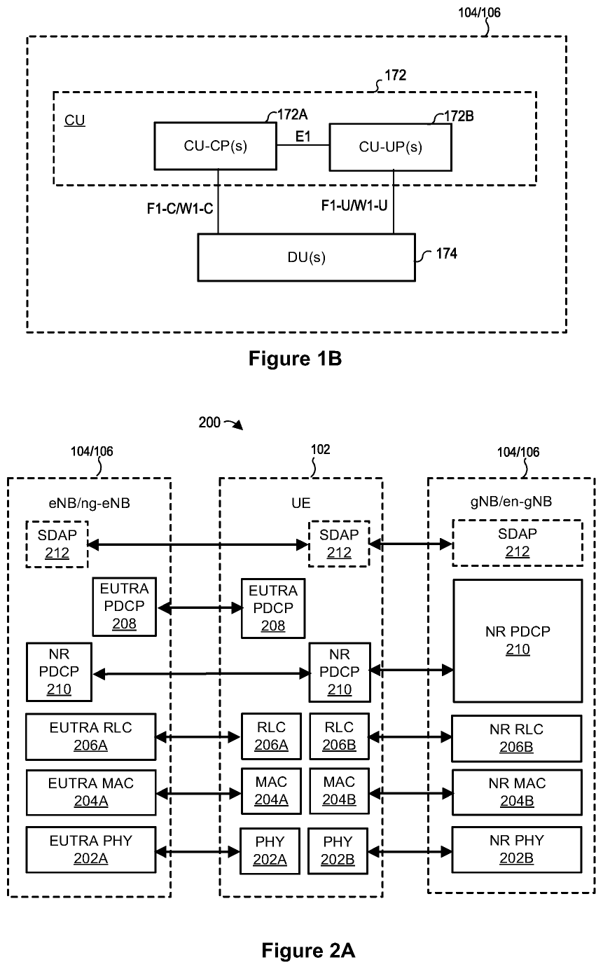

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

The CN 110 may also communicatively connect the UE 102 to an Internet Protocol (IP) Multimedia Subsystem (IMS) network 170, via the RAN 105. The IMS network 170 can provide to the UE 102 various IMS services, such as IMS short messages, IMS unstructured supplementary service data (USSD), IMS value added service data, IMS supplementary service data, IMS voice calls, and IMS video calls. To this end, an entity (e.g., a server or a group of servers) operating in the IMS network 170 supports packet exchange with the UE. The packets can convey signaling (such as session initiation protocol (SIP) messages, IP messages, or other suitable messages) as well as data (“or media”) such as voice or video.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol. As discussed below, the UE 102 in some implementations applies the techniques of this disclosure only if the size of the data (e.g., UL data) is below a certain threshold value.

In the example scenarios discussed below, the UE 102 transitions to the RRC_INACTIVE or RRC_IDLE state, selects a cell of the base station 104, and exchanges data with the base station 104, either via the base station 106 or with the base station 104 directly, without transitioning to RRC_CONNECTED state. As a more specific example, after the UE 102 determines that data is available for uplink transmission in the RRC_INACTIVE or RRC_IDLE state, the UE 102 can apply one or more security functions to an uplink (UL) data packet, generate a first UL protocol data unit (PDU) including the security-protected packet, include a UL RRC message along with the first UL PDU in a second UL PDU, and transmit the second UL PDU to the RAN 105. The UE 102 includes a UE identity/identifier (ID) for the UE 102 in the UL RRC message. The RAN 105 can identify the UE 102 based on the UE ID. In some implementations, the UE ID can be an inactive Radio Network Temporary Identifier (I-RNTI), a resume ID, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105 while in the RRC_INACTIVE or RRC_IDLE state.

In some implementations, the data is a UL service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may omit a UL RRC message from the UL MAC PDU. In this latter case, the UE 102 may omit a UE ID of the UE 102 from the UL MAC PDU that does not include a UL RRC message. In yet further implementations, the UE 102 can include the UL PDCP PDU in a UL radio link control (RLC) PDU and then include the UL RLC PDU in the UL MAC PDU. In some implementations in which the UL RRC message is included in the UL MAC PDU, the UE 102 generates an RRC MAC-I and includes the RRC MAC-I in the UL RRC message. For example, the RRC MAC-I may be a resumeMAC-I field, as specified in 3GPP specification 38.331. In further implementations, the UE can obtain the RRC MAC-I from the UL RRC message with an integrity key (e.g., KRRCint key), an integrity protection algorithm, and the parameters COUNT (e.g., 32-bit, 64-bit or 128-bit value), BEARER (e.g., 5-bit value) and DIRECTION (e.g., 1-bit value).

In further implementations, the data is a UL SDU of the NAS. The UE 102 applies the security function to the SDU and includes the secured SDU in a first UL PDU such as a NAS PDU, which can be associated with the NAS layer. For example, the NAS layer can be an MM sublayer or SM sublayer of 5G, Evolved Packet System (EPS), or 6G. The UE 102 can then include the UL NAS PDU in a second UL PDU such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may not include an RRC MAC-I in the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based on the determined UE ID. In such scenarios, the base station 106 can be referred as the “anchor” base station that sent the UE 102 into the inactive state while retaining the full UE context information. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 104 derives at least one security key from UE context information of the UE 102. Then the base station 104 retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an encryption and/or decryption key). If the security-protected packet is an integrity-protected packet, the integrity-protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. However, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UL PDU. The base station 106 performs a retrieve UE context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an encryption and/or decryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the CN 110. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieves the data from the security-protected packet, and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 currently operating in the RRC_INACTIVE or RRC_IDLE state, the base station 104 can apply at least one security function to the data to generate a security-protected packet, generate a first DL PDU including the security-protected packet, and the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that the security-protected packet includes the data and the MAC-I. When encryption is enabled, the base station 104 encrypts the data to generate an encrypted packet, so that the security-protected packet is an encrypted packet. Further, when both integrity protection and encryption are enabled, the base station 104 can generate a MAC-I for protecting the integrity of the data and encrypt the data along with the MAC-I to generate an encrypted packet and an encrypted MAC-I. The base station 104 in some implementations generates a first DL PDU, such as a DL PDCP PDU, using the security-protected packet, includes the first DL PDU in a second DL PDU associated with the MAC layer for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, includes the DL RLC PDU in the DL MAC PDU and transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU), including the DL RLC PDU, and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response that the base station transmits in a random access procedure with the UE 102 before transmitting the DCI and scrambled CRC. In further implementations, the base station may assign the ID of the UE 102 to the UE 102 in an RRC message (e.g., RRC release message or an RRC reconfiguration message) that the base station transmits to the UE 102 before transmitting the DCI and scrambled CRC, e.g., while the UE 102 was in the RRC_CONNECTED state.

The UE 102 operating in the RRC_INACTIVE or RRC_IDLE state can receive the DCI and scrambled CRC on the PDCCH. The UE 102 then confirms that a physical downlink shared channel (PDSCH), including the second DL PDU, is addressed to the UE 102 according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected, with encrypted data and an encrypted MAC-I, the UE 102 can decrypt the encrypted packet and encrypted MAC-I to obtain the data and the MAC-I. The UE 102 can then verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction in some scenarios, and receive UL PDCP PDUs in accordance with which the base station 104 can receive data in the uplink direction in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 140, 142, 144, 146, and 148 of the base station 106 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154 configured to transmit DL PDCP PDUs in accordance with which the base station 106 can transmit data in the downlink direction in some scenarios, and receive UL PDCP PDUs in accordance with which the base station 106 can receive data in the uplink direction in other scenarios. The processing hardware further can include an RRC controller 156 to implement procedures and messaging at the RRC sublayer of the protocol communication stack.

FIG. 1B depicts an example distributed or disaggregated implementation of any one or more of the base stations 104, 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

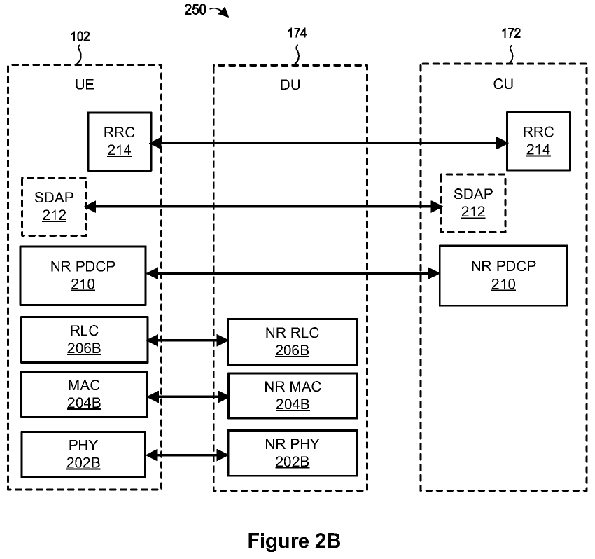

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

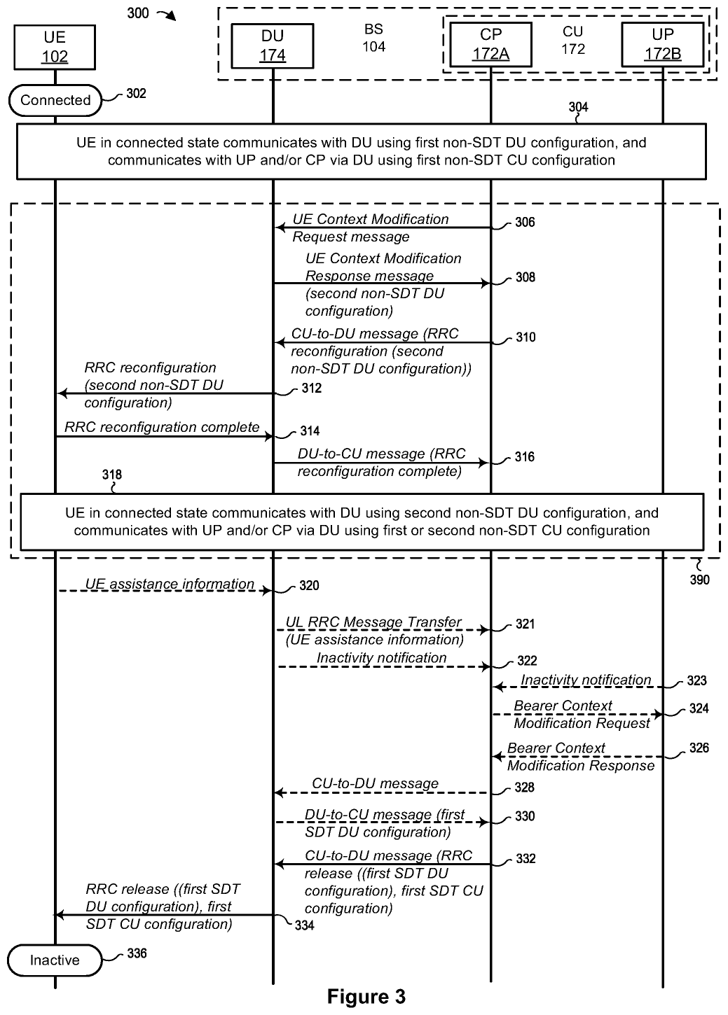

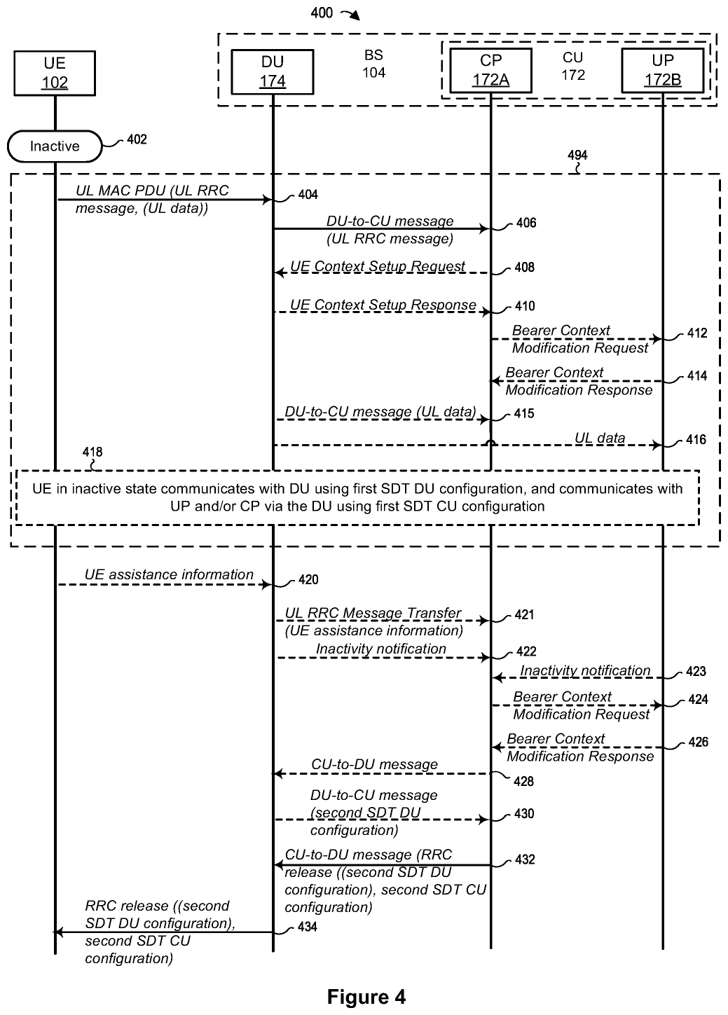

Next, several example scenarios that involve several components of FIG. 1A and relate to transmitting data in an inactive or idle state are discussed next with reference to FIGS. 3 and 4. To simplify the following description, the term “inactive state” is used and can represent the RRC_INACTIVE or RRC_IDLE state, and the “connected state” is used and can represent the RRC_CONNECTED state.

Referring first to FIG. 3, in a scenario 300, the base station 104 includes a central unit (CU) 172 and a distributed unit (DU) 174, and the CU 172 includes a CU-CP 172A and a CU-UP 172B. In this scenario 300, the UE 102 initially operates in a connected state 302 and communicates 304 with the DU 174 using a DU configuration (i.e., a first non-SDT DU configuration), and communicates 304 with the CU-CP 172A and/or CU-UP 172B via the DU 174 using a CU configuration (i.e., a first non-SDT CU configuration). While the UE communicates 304 with the base station 104, the CU-CP 172A can send 306 a UE Context Modification Request message to the DU 174. In response, the DU 174 sends 308 a UE Context Modification Response message including a non-SDT DU configuration (i.e., a second non-SDT DU configuration) for the UE 102 to the CU-CP 172A. The CU-CP 172A generates a RRC reconfiguration message including the second non-SDT DU configuration and transmits 310 a first CU-to-DU message (e.g., DL RRC Message Transfer message) including the RRC reconfiguration message to the DU 174. In turn, the DU 174 transmits 312 the RRC reconfiguration message to the UE 102. In response, the UE 102 transmits 314 a RRC reconfiguration complete message to the DU 174, which in turn transmits 316 a first DU-to-CU message (e.g., UL RRC Message Transfer message) including the RRC reconfiguration complete message to the CU-CP 172A.

After receiving 312 the RRC reconfiguration message, the UE 102 in the connected state communicates 318 with the DU 174 using the second non-SDT DU configuration and communicates with the CU-CP 172A and/or CU-UP 172B via the DU 174. In cases where the RRC reconfiguration message does not include a CU configuration, the UE 102 communicates 318 with the CU-CP 172A and/or CU-UP 172B via the DU 174 using the first non-SDT CU configuration. In cases where the RRC reconfiguration message includes a non-SDT CU configuration (i.e., a second non-SDT CU configuration), the UE 102 communicates 318 with the CU-CP 172A and/or CU-UP 172B via the DU 174, using the second non-SDT CU configuration. In some implementations, the second non-SDT CU configuration can augment the first non-SDT CU configuration or include at least one new configuration parameter not included in the first non-SDT CU configuration. In such cases, the UE 102 and the CU-CP 172A and/or the CU-UP 172B can communicate 318 with one another using the second non-SDU CU configuration, and also the configuration parameters in the first non-SDT CU configuration that were not augmented by the second non-SDU CU configuration. In some implementations, the first non-SDT CU configuration includes configuration parameters, related to operations of RRC and/or PDCP protocol layers (e.g., RRC 214 and/or NR PDCP 210), that the UE 102 and CU 172 use to communicate with one another while the UE 102 operates in the connected state. Similarly, the second non-SDT CU configuration can include configuration parameters, related to operations of the RRC and/or PDCP protocol layers, that the UE 102 and CU 172 use to communicate with one another while the UE 102 operates in the connected state. In some implementations, the first non-SDT CU configuration includes configuration parameters in a RadioBearerConfig information element (IE) and/or MeasConfig IE defined in 3GPP specification 38.331 v16.7.0. Similarly, the second non-SDT CU configuration includes configuration parameters in the RadioBearerConfig IE and/or MeasConfig IE defined in 3GPP specification 38.331 v16.7.0. In some implementations, the first non-SDT CU configuration can be or include a RadioBearerConfig IE and/or a MeasConfig IE, and the second non-SDT CU configuration can be or include a RadioBearerConfig IE and/or MeasConfig IE.

In some implementations, the second non-SDT DU configuration can augment the first non-SDT DU configuration or include at least one new configuration parameter not included in the first non-SDT DU configuration. In such cases, the UE 102 and the DU 174 can communicate 318 with one another using the second non-SDU DU configuration, and also the configuration parameters in the first non-SDT DU configuration that were not augmented by the second non-SDU DU configuration. In some implementations, the first non-SDT DU configuration includes configuration parameters, related to operations of RRC, RLC, MAC, and/or PHY protocol layers (e.g., RLC 206B, MAC 204B and/or PHY 202B), that the UE 102 and DU 174 use to communicate with one another while the UE 102 operates in the connected state. Similarly, the second non-SDT DU configuration can include configuration parameters, related to operations of the RRC, RLC, MAC, and/or PHY protocol layers, that the UE 102 and DU 174 use to communicate with one another while the UE 102 operates in the connected state. In some implementations, the first non-SDT DU configuration includes configuration parameters in a CellGroupConfig IE defined in 3GPP specification 38.331 v16.7.0. Similarly, the second non-SDT DU configuration includes configuration parameters in the CellGroupConfig IE defined in 3GPP specification 38.331 v16.7.0. In some implementations, the first non-SDT DU configuration and the second non-SDT DU configuration are CellGroupConfig IEs.

The events 306, 308, 310, 312, 314, 316 and 318 are collectively referred to in FIG. 3 as a non-SDT resource (re) configuration procedure 390, which can be optional.

While the UE 102 communicates with the base station 104, or after the non-SDT resource (re) configuration procedure 390 (if performed), the CU-CP 172A can determine to transition the UE 102 to an inactive state from the connected state, based on data inactivity of the UE 102 (i.e., based on the UE 102 in the connected state having no data activity with the base station 104). In some implementations, while the UE 102 communicates with the base station 104, or after the non-SDT resource (re) configuration procedure 390 (if performed), the UE 102 determines or detects data inactivity and transmits 320, to the DU 174, UE assistance information (e.g., a UEAssistanceInformation message) indicating that the UE 102 prefers or requests to transition to the inactive state with SDT configured. In turn, the DU 174 transmits 321 a UL RRC Message Transfer message including the UE assistance information to the CU-CP 172A. Thus, the CU-CP 172A can determine that the UE 102 is in data inactivity based on the UE assistance information. In other implementations, the DU 174 can perform data inactivity monitoring for the UE 102. The CU-CP 172A can transmit a CU-to-DU message (e.g., a UE Context Setup Request message or a UE Context Modification Request message) to the DU 174 to request or command the DU 174 to perform the data inactivity monitoring, for example. In cases where the DU 174 detects or determines that the UE 102 is in data inactivity during the monitoring, the DU 174 can transmit 322 an inactivity notification (e.g., a UE Inactivity Notification message) to the CU-CP 172A. Thus, the CU-CP 172A can determine that the UE 102 is in data inactivity based on the inactivity notification received from the DU 174. In yet other implementations, the CU-UP 172B can perform data inactivity monitoring for the UE 102. The CU-CP 172A can transmit a CP-to-UP message (e.g., a Bearer Context Setup Request message or a Bearer Context Modification Request message) to the CU-UP 172B to request or command the CU-UP 172B to perform the data inactivity monitoring, for example. In cases where the CU-UP 172B detects or determines that the UE 102 is in data inactivity during the monitoring, the CU-UP 172B can transmit 323 an inactivity notification (e.g., a Bearer Context Inactivity Notification message) to the CU-CP 172A. Thus, the CU-CP 172A can determine that the UE 102 is in data inactivity based on the inactivity notification received from the CU-UP 172B. In some implementations, the CU-CP 172A can determine that the UE 102 is in data inactivity based on any combination of the UE assistance information, the inactivity notification of the event 322, and/or the inactivity notification of the event 323.

After a certain period of data inactivity, the CU-CP 172A can determine that the CU 172 and the UE 102 have not transmitted any data in the downlink direction or the uplink direction, respectively, during the certain period (e.g., using any of the techniques described above for the UE inactivity determination). In response to the determination, the CU-CP 172A can determine to transition the UE 102 to the inactive state with SDT configured. Alternatively, the CU-CP 172A can determine to immediately transition the UE 102 to the inactive state with SDT configured in response to determining that the UE 102 is in data inactivity, irrespective of whether the CU 172 has transmitted data in the downlink direction in any particular time period.

In response to or after determining that the UE 102 is in data inactivity (for the certain period) or otherwise in response to determining to transition the UE 102 to the inactive state with SDT configured, the CU-CP 172A sends 324 to the CP-CU 172B a Bearer Context Modification Request message to suspend data transmission for the UE 102. In response, the CU-UP 172B suspends data transmission for the UE 102 and sends 326 a Bearer Context Modification Response message to the CU-CP 172A. Also in response to or after determining that the UE 102 is in data inactivity (for the certain period) or otherwise in response to determining to transition the UE 102 to the inactive state with SDT configured, the CU-CP 172A sends 328 a second CU-to-DU message (e.g., a UE Context Modification Request message) to instruct the DU 174 to provide (i.e., request from the DU 174) a SDT DU configuration for the UE 102. In some implementations, the CU-CP 172A can include a SDT request indication (e.g., a field or IE) to request a SDT DU configuration in the second CU-to-DU message. In response to the SDT request indication or the second CU-to-DU message, the DU 174 transmits 330 a second DU-to-CU message (e.g., UE Context Modification Response message) that includes a first SDT DU configuration to the CU-CP 172A. Alternatively, the DU 174 does not include a SDT DU configuration in the second DU-to-CU message, and the DU 174 instead sends to the CU-CP 172A another DU-to-CU message (e.g., UE Context Modification Required message) including the first SDT DU configuration, after receiving the second CU-to-DU message (event 328) and/or after transmitting the second DU-to-CU message (event 330). In some alternative implementations, the CU-CP 172A can transmit the second CU-to-DU message and receive the second DU-to-CU message (or receive the alternative DU-to-CU message discussed above) before determining that the UE 102 is in data inactivity. In other alternative implementations, the CU-CP 172A can include the SDT request indication in the first CU-to-DU message of the event 308 and the DU 174 includes the first SDT DU configuration in the first DU-to-CU message of the event 310 in response to the SDT request indication.

In response to determining to transition the UE 102 to the inactive state with SDT configured, the CU-CP 172A can generate a RRC release message (e.g., RRCRelease message or RRCConnectionRelease message) to transition the UE 102 to the inactive state. The CU-CP 172A can include the first SDT DU configuration and a first SDT CU configuration in the RRC release message. The CU-CP 172A then sends 332 to the DU 174 a third CU-to-DU message (e.g., a UE Context Release Command message or a UE Context Modification Request message) which includes the RRC release message. In turn, the DU 174 transmits 334 the RRC release message to the UE 102. The RRC release message instructs the UE 102 to transition to the inactive state. The UE 102 transitions 336 to the inactive state from the connected state upon receiving the RRC release message. In response to the third CU-to-DU message, the DU 174 can retain the first SDT DU configuration and may or may not release the first non-SDT DU configuration and/or second non-SDT DU configuration. The DU 174 can send a third DU-to-CU message (e.g., a UE Context Release Complete message or a UE Context Modification Response message) to the CU-CP 172A in response to the third CU-to-DU message.

In some implementations, the UE 102 releases the first non-SDT DU configuration and/or second non-SDT DU configuration, or at least a portion of the first non-SDT DU configuration and/or second non-SDT DU configuration, in response to the RRC release message. In other implementations, if the RRC release message instructs the UE 102 to transition to the inactive state (i.e., RRC_IDLE), the UE 102 releases the first non-SDT DU configuration and/or second non-SDT configuration. In yet other implementations, if the RRC release message instructs the UE to transition to the inactive state (i.e., RRC_INACTIVE), the UE 102 releases a first portion of the first and/or second non-SDT DU configurations and retains a second portion of the first and/or second non-SDT DU configurations.

In some implementations, the CU-CP 172A does not include an indication in the third CU-to-DU message to instruct the DU 174 to retain the first SDT DU configuration, but the DU 174 nonetheless retains the first SDT DU configuration as described above. In another implementation, the CU-CP 172A can include an indication in the third CU-to-DU message to instruct the DU 174 to retain the first SDT DU configuration, and the DU 174 retains the first SDT DU configuration in response to the indication. In this implementation, if the DU 174 receives from the CU-CP 172A a UE Context Release Command message for the UE 102 excluding the indication, the DU 174 releases the first SDT DU configuration. In yet another implementation, the CU-CP 172A does not include an indication in the third CU-to-DU message to instruct the DU 174 to release the first SDT DU configuration, and the DU 174 retains the first SDT DU configuration in response to the third CU-to-DU message excluding the indication. In this implementation, the DU 174 receives from the CU-CP 172A a CU-to-DU message (e.g., a UE Context Release Command message or a UE Context Modification Request message) for the UE 102 including the indication, the DU 174 releases the first SDT DU configuration.

In some implementations, the first SDT CU configuration includes a DRB list (e.g., a std-DRB-List) including a list of DRB ID(s) indicating ID(s) of DRB(s) configured for SDT. In some implementations, the first SDT CU configuration can include a SRB2 indication (e.g., sdt-SRB2-Indication) indicating a SRB2 configured for SDT. In some implementations, the first SDT CU configuration can include a compression protocol continue indication (e.g., sdt-DRB-ContinueROHC) indicating whether a PDCP entity for the DRB(s) configured for SDT, during SDT operation (i.e., initial and/or subsequent SDT as described in FIG. 4), continues. In some implementations, the first SDT CU configuration can include a data volume threshold (e.g., sdt-Data VolumeThreshold) for the UE 102 to determine whether SDT can be initiated.

In some implementations, the first SDT DU configuration can include at least one common SDT configuration, at least one RA-SDT configuration, and/or at least one CG-SDT configuration for CG-SDT. For example, the at least one common SDT configuration can include a buffer status reporting (BSR) configuration and/or a power headroom reporting (PHR) configuration. In another example, the at least one RA-SDT configuration can include random access configuration parameters for two-step and/or four-step random access procedures. In another example, the at least one CG-SDT configuration includes a configured grant configuration for CG-SDT, a time alignment timer value for CG-SDT, and/or a timing advance validity threshold. The DU 174 configures the timing advance validity threshold for the UE 102 to determine whether the UE 102 can perform SDT using the configured grant configuration for CG-SDT. In accordance with the timing advance validity threshold, the UE 102 can evaluate whether a stored timing advance value is still valid. If the UE 102 determines that the stored timing advanced value is invalid, the UE 102 can perform a RA-SDT with the CU 172 via the DU 174 as described for FIG. 4.

In the case where the DU 174 provides the CG-SDT configuration to the CU-CP 172A at event 330, the DU 174 retains radio resources configured by the at least CG-SDT configuration while retaining the first SDT DU configuration. In some implementations, the DU 174 releases radio resources configured by the CG-SDT configuration when releasing the first SDT DU configuration or the CG-SDT configuration. In cases where the DU 174 does not provide the CG-SDT configuration to the CU-CP 172A, the DU 174 releases all related signaling and user data transport resources for the UE 102 in response to the third CU-to-DU message. In cases where the DU 174 provides the CG-SDT configuration to the CU-CP 172A, the DU 174 retains all related signaling and user data transport resources for the UE 102 in response to or after receiving the third CU-to-DU message.

In cases where the first SDT DU configuration does not include a configuration for CG-SDT, the CU-CP 172A and/or the DU 174 only configures RA-SDT for the UE 102. In such cases, the UE 102 can perform RA-SDT with the CU 172 via the DU 174 as described for FIG. 4.

In some implementations, the CU-CP 172A may not request the DU 174 to provide a SDT DU configuration for transitioning the UE 102 to the inactive state with SDT configured. In such cases, the events 328 and 330 can omitted, and the CU-CP 172A does not include a SDT DU configuration in the RRC release message. Instead, the CU-CP 172A may generate the first SDT DU configuration by itself without requesting the DU 174 to provide a SDT DU configuration, and include the first SDT DU configuration in the RRC release message.

In some implementations, the DU 174 may not include a SDT DU configuration in the second DU-to-CU message, e.g., if or because the UE 102 does not support CG-SDT, the DU 174 does not support CG-SDT, or the DU 174 does not have available radio resources for CG-SDT. In such cases, the RRC release message does not include a SDT DU configuration. Otherwise, the DU 174 can include the first SDT DU configuration as described above. In some implementations, the DU 174 may not include a CG-SDT configuration in the first SDT DU configuration in the second DU-to-CU message, e.g., if or because the UE 102 does not support CG-SDT, the DU 174 does not support CG-SDT, or the DU 174 does not have available radio resources for CG-SDT. In such cases, the first SDT DU configuration does not include a CG-SDT configuration. Otherwise, the DU 174 can include the at least one CG-SDT configuration in the first SDT DU configuration as described above.

In some implementations, the CU-CP 172A may request the DU 174 to provide a SDT DU configuration as described above, in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide a SDT DU configuration. The CU-CP 172A can receive a UE capability (e.g., UE-NR-Capability IE) of the UE 102 from the UE 102, the CN 110 (e.g., MME 114 or AMF 164) or the base station 106, while the UE operates 302 in the connected state. The UE capability indicates whether the UE 102 supports CG-SDT. Thus, the CU-CP 172A can determine whether the UE supports CG-SDT in accordance with the UE capability. In some implementations, the CU-CP 172A can receive from the DU 174 a DU-to-CU message indicating whether the DU 174 supports CG-SDT. The DU-to-CU message can be the second DU-to-CU message, the message of the event 308 or 316, or a non-UE associated message (e.g., a non-UE associated F1AP message defined in 3GPP specification 38.473).

In some implementations, the DU 174 may determine whether to provide a SDT DU configuration for the UE 102 to the CU-CP 172A, based on whether the UE 102 supports CG-SDT or not. In addition to whether the UE 102 supports CG-SDT or not, the DU 174 may additionally determine whether to provide a SDT DU configuration for the UE 102 to the CU-CP 172A, based on whether the DU 174 supports CG-SDT or not. In cases where the UE 102 supports CG-SDT and/or the DU 174 supports CG-SDT, the DU 174 provides the first SDT DU configuration for the UE 102 to the CU-CP 172A as described above. In cases where the UE 102 does not support CG-SDT or the DU 174 does not support CG-SDT, the DU 174 does not provide a SDT DU configuration for the UE 102 (e.g., the DU 174 does not include the first SDT DU configuration in the second DU-to-CU message). The DU 174 can receive the UE capability from the CU-CP 172A, while the UE operates 302 in the connected state or in the inactive state before the event 302. Thus, the DU 174 can determine whether the UE supports CG-SDT in accordance with the UE capability. In some implementations, the DU 174 can send a DU-to-CU message to the CU-CP 172A to indicate whether the DU 174 does support CG-SDT or not, as described above.

Referring next to FIG. 4, a scenario 400 depicts small data transmission. In the scenario 400, the base station 104 includes a CU 172 and a DU 174. The CU 172 includes a CU-CP 172A and a CU-UP 172B. In the scenario 400, the UE 102 initially operates 402 in an inactive state with SDT configured. In some implementations or scenarios, prior to the events shown in FIG. 4, the UE 102 can transition to the inactive state with SDT configured from the connected state as described for FIG. 3 (i.e., event 402 can follow event 336). In other implementations or scenarios, prior to the events shown in FIG. 4, the UE 102 can transition to the inactive state with SDT configured from the inactive state without SDT configured. For example, the UE 102 can receive from a base station (e.g., the base station 104 or base station 106) a RRC release message transitioning the UE 102 to the inactive state and not including a SDT configuration. In this case, the UE 102 transitions to the inactive state without SDT configured in response to the RRC release message. The UE 102 in the inactive state with or without SDT configured may perform a RAN notification area (RNA) update with the base station without state transitions. During the RNA update, the UE 102 receives another RRC release message including a first SDT CU configuration and/or a first SDT DU configuration from the base station, similar to the RRC release message of the event 334.

Later in time, the UE 102 operating in the inactive state with SDT configured initiates SDT. In response to or after initiating SDT, the UE 102 generates an initial UL MAC PDU, which includes a UL RRC message and transmits 404 the initial UL MAC PDU to the DU 174 on the cell 124. The UE 102 may start a SDT timer in response to initiating the SDT. The DU 174 retrieves the UL RRC message from the initial UL MAC PDU, generates a first DU-to-CU message including the UL RRC message, and sends 406 the first DU-to-CU message to the CU-CP 172A. In some implementations, the first DU-to-CU message can be an Initial UL RRC Message Transfer message. In other implementations, the first DU-to-CU message can be a UL RRC Message Transfer message.

In scenarios in which the UE 102 initiates SDT to transmit UL data (e.g., a data packet) qualifying for SDT, the UE 102 includes the UL data in the initial UL MAC PDU that the UE 102 transmits 404. In scenarios in which the UE 102 initiates SDT to receive DL data, the UE 102 does not include an UL data packet in the initial UL MAC PDU that the UE 102 transmits 404. The UE 102 can initiate SDT to receive DL data in response to receiving a paging from the DU 174. In such scenarios, the UE 102 can include a SDT indication in the initial UL MAC PDU or the UL RRC message to indicate to the base station 104 that the UE 102 is initiating SDT to receive DL data.

In some implementations, the UE 102 can include a buffer status report or a power headroom report in the initial UL MAC PDU of the event 404. In other implementations, the UE 102 refrains from including a buffer status report and/or a power headroom report in the initial UL MAC PDU of the event 404, e.g., in accordance with the BSR configuration and/or PHR configuration, respectively. In the buffer status report, the UE 102 can include or indicate its buffer status for one or more logical channels or logical channel groups. In the power headroom report, the UE 102 can include or indicate power headroom status or value.

In some implementations, the UE 102 in the inactive state performs a random access procedure with the DU 174 to transmit 404 the UL MAC PDU. In such cases, the SDT is a RA-SDT. For example, the random access procedure can be a four-step random access procedure or a two-step random access procedure. In the case of the four-step random access procedure, the UE 102 transmits a random access preamble to the DU 174 and, in response, the DU 174 transmits to the UE 102 a random access response (RAR) including an uplink grant, and the UE 102 transmits 404 the UL MAC PDU in accordance with the uplink grant. The DU 174 receives 404 the UL MAC PDU in accordance with the uplink grant in the RAR. In the case of the two-step random access procedure, the UE 102 transmits 404 to the DU 174 a message A including a random access preamble and the UL MAC PDU in accordance with two-step random access configuration parameters. The UE 102 receives the two-step random access configuration parameters in system information broadcast by the DU 174 on the cell 124 before transmitting 404 the UL MAC PDU. The DU 174 receives 404 the UL MAC PDU in accordance with the two-step random access configuration parameters.

In further implementations, the UE 102 can transmit 404 the UL MAC PDU on radio resources configured in a configured grant (CG) configuration for SDT in cases where the UE 102 received a CG-SDT configuration as described for FIG. 3. Thus, the DU 174 receives 404 the UL MAC PDU on the radio resources. In such implementations, the UE 102 can transmit (at event 418) subsequent UL MAC PDU(s) including one or more UL data packets, discussed below, on radio resources configured in the CG configuration.

If the UE 102 includes UL data in the initial UL MAC PDU, the DU 174 retrieves the UL data from the initial UL MAC PDU. In such cases, the DU 174 can include the UL data in the DU-to-CU message of the event 406. Alternatively, the DU 174 can send the UL data to the CU-CP 172A separately, in a DU-to-CU message (i.e., event 415). In some implementations, the DU-to-CU message of event 415 can be a UL RRC Message Transfer message. As yet another alternative, the DU 174 can send 416 the UL data to the CU-UP 172B separately via a user-plane (UP) connection as described below (i.e., event 416). After receiving 406 the first DU-to-CU message, the CU-CP 172A in some implementations can send 408 a UE Context Setup Request message to the DU 174 to establish a UE Context of the UE 102 at the DU 174. In the UE Context Setup Request message, the CU-CP 172A can include transport layer information for one or more GTP-U tunnels between the CU-UP 172B and DU 174 so that the DU 174 can transmit the UL data and/or subsequent UL data (e.g., in small data communication 418) via the one or more GTP-U tunnels to the CU-UP 172B. In response, the DU 174 can send 410 a UE Context Setup Response message to the CU-CP 172A. After receiving 406 the first DU-to-CU message, transmitting 408 the UE Context Setup Request message, and/or receiving 410 the UE Context Setup Response message, the CU-CP 172A transmits 412 to the CU-UP 172B a Bearer Context Modification Request message to resume data transmission for the UE 102. In response, the CU-UP 172B resumes data transmission for the UE 102 and transmits 414 a Bearer Context Modification Response message to the CU-CP 172A. After receiving 408 the UE Context Setup Request message and/or transmitting 410 the UE Context Setup Response message, the DU 174 can transmit 415 the DU-to-CU message including the UL data to the CU-CP 172A, in cases where the UL data packet (received at the event 404) includes a RRC message or is associated with a SRB (e.g., SRB1 or SRB2). In cases where the UL data packet is associated with a DRB, the DU 174 can transmit 416 the UL data packet to the CU-UP 172B via one of the one or more GTP-U tunnels.

In some implementations, the CU-CP 172A can include transport layer information of the CU-UP 172B in the UE Context Setup Request message. The transport layer information of the CU-UP 172B can include an IP address and/or an uplink tunnel endpoint ID (e.g., TEID). The DU 174 can transmit 416 the UL data to the CU-UP 172B using the transport layer information of the CU-UP 172B. In cases where the UE 102 has subsequent UL data (e.g., one or more UL data packets) to transmit, the UE 102 can transmit (at event 418) one or more subsequent UL MAC PDUs including the subsequent UL data to the DU 174. In turn, the DU 174 retrieves the subsequent UL data from the subsequent UL MAC PDU(s). In cases where the subsequent UL data is associated with one or more SRB (e.g., SRB1 and/or SRB2), the DU 174 transmits 418 the one or more DU-to-CU messages including the subsequent UL data to the CU-CP 172A. Each DU-to-CU message can include a particular UL data packet of the subsequent UL data. In cases where the subsequent UL data is associated with one or more DRBs, the DU 174 transmits (at event 418) the subsequent UL data to the CU-UP 172B. In some implementations, the DU 174 can include transport layer information of the DU 174 in the UE Context Setup Response message. In turn, the CU-CP 172A can include the transport layer information of the DU 174 in the Bearer Context Modification Request message. The transport layer information of the DU 174 can include an IP address and/or a downlink TEID. In cases where the CU-UP 172B receives DL data from the CN 110 or an edge server, the CU-UP 172B can transmit 418 the DL data (e.g., one or more DL data packets) to the DU 174 using the transport layer information of the DU 174. In turn, the DU 174 transmits (at event 418) one or more DL MAC PDUs including the DL data to the UE 102 operating in the inactive state. In some implementations, the UE 102 can include a buffer status report or a power headroom report in the subsequent UL MAC PDU(s), e.g., in accordance with the BSR configuration and/or PHR configuration, respectively. In the buffer status report, the UE 102 can include or indicate its buffer status for one or more logical channels or logical channel groups. In the power headroom report, the UE 102 can include or indicate power headroom status or value.

In some example scenarios, the (subsequent) UL data and/or DL data described above include Internet Protocol (IP) packet(s), an Ethernet packet(s), or an application packet(s). In other scenarios, the UL data include PDU(s) (e.g., RRC PDU(s), PDCP PDU(s) or RLC PDU(s)) that includes RRC message(s), NAS message(s), IP packet(s), Ethernet packet(s), or application packet(s).

The events 404, 406, 408, 410, 412, 414, 415 and 416 are collectively referred to in FIG. 4 as a small data transmission procedure 494.

In some implementations, the UL RRC message is an (existing) RRC resume request message (e.g., an RRCResumeRequest message, an RRCResumeRequest1 message, an RRCConnectionResumeRequest message, or an RRCConnectionResumeRequest1 message). In other implementations, the UL RRC message can be a new RRC resume request message, similar to the existing RRC resume request message. For example, the new RRC resume request message may be defined in future 3GPP standards documentation. The new RRC resume request message may be a format of an existing RRC resume request message. In the case of the downlink SDT, the UL RRC message can include a SDT indication, which can be a field or information element (IE) (e.g., resumeCause or ResumeCause). In some implementations, the UL RRC message is a common control channel (CCCH) message.

After the UE 102 transmits 404 the UL MAC PDU or communicates 418 the subsequent UL data and/or DL data with the DU 174, the CU-CP 172A can determine to stop the SDT for the UE 102 based on data inactivity of the UE 102 (i.e., the UE 102 in the inactive state has no data activity with the base station 104). For example, after the UE 102 transmits 404 the UL MAC PDU or communicates 418 the subsequent UL data and/or DL data with the DU 174, the UE 102 in the inactive state can determine or detect data inactivity and transmit 420 to the DU 174 UE assistance information (e.g., a UEAssistanceInformation message) indicating that the UE 102 prefers or requests to stop the SDT. In turn, the DU 174 transmits 421 a UL RRC Message Transfer message including the UE assistance information to the CU-CP 172A. Thus, the CU-CP 172A can determine that the UE 102 is in data inactivity based on the UE assistance information. In other implementations, the DU 174 can perform data inactivity monitoring for the UE 102. For example, the CU-CP 172A can transmit a CU-to-DU message (e.g., the UE Context Setup Request message of the event 408 or a UE Context Modification Request message) to the DU 174 to request or command the DU 174 to perform the data inactivity monitoring. In cases where the DU 174 detects or determines that the UE 102 is in data inactivity during the monitoring, the DU 174 can transmit 422 an inactivity notification (e.g., UE Inactivity Notification message) to the CU-CP 172A. Thus, the CU-CP 172A can determine that the UE 102 is in data inactivity based on the inactivity notification received from the DU 174. In yet other implementations, the CU-UP 172B can perform data inactivity monitoring for the UE 102. For example, the CU-CP 172A can transmit a CP-to-UP message to the CU-UP 172B to request or command the CU-UP 172B to perform the data inactivity monitoring. In some implementations, the CP-to-UP message can be a Bearer Context Setup Request message or a Bearer Context Modification Request message before the UE 102 initiates the SDT. In other implementations, the CP-to-UP message can be a Bearer Context Modification Request message during the SDT (e.g., the event 412). In cases where the CU-UP 172B detects or determines that the UE 102 is in data inactivity during the monitoring, the CU-UP 172B can transmit 423 an inactivity notification (e.g., Bearer Context Inactivity Notification message) to the CU-CP 172A. Thus, the CU-CP 172A can determine that the UE 102 is in data inactivity based on the inactivity notification received from the CU-UP 172B. In some implementations, the CU-CP 172A can determine that the UE 102 is in data inactivity based on any combination of the UE assistance information, inactivity notification of the event 422, and/or inactivity notification of the event 423.

After a certain period of data inactivity, the CU-CP 172A can determine that neither the CU 172 nor the UE 102 has transmitted any data in the downlink direction or the uplink direction, respectively, during the certain period (e.g., using any of the techniques described above for the UE inactivity determination). In response to the determination, the CU-CP 172A can determine to stop the SDT. Alternatively, the CU-CP 172A can determine to immediately stop the SDT for the UE 102 in response to determining that the UE 102 is in data inactivity, irrespective of whether the CU 172 has transmitted data in the downlink direction in any particular time period.

In response to or after determining that the UE 102 is in data inactivity (for the certain period) or otherwise determining to stop the SDT, the CU-CP 172A sends 424 to the CP-CU 172B a Bearer Context Modification Request message to suspend data transmission for the UE 102. In response, the CU-UP 172B suspends data transmission for the UE 102 and sends 426 a Bearer Context Modification Response message to the CU-CP 172A. In response to or after determining that the UE 102 is in data inactivity (for the certain period) or otherwise determining to stop SDT, the CU-CP 172A sends 428 a second CU-to-DU message (e.g., a UE Context Modification Request message) to instruct the DU 174 to provide (i.e., request from the DU 174) a SDT DU configuration for the UE 102. In some implementations, the CU-CP 172A can include a SDT request indication (e.g., a field or IE) to request a SDT DU configuration in the second CU-to-DU message. In response to the SDT request indication or the second CU-to-DU message, the DU 174 transmits 430 a second DU-to-CU message (e.g., UE Context Modification Response message) including a second SDT DU configuration to the CU-CP 172A. Alternatively, the DU 174 does not include a SDT DU configuration in the second DU-to-CU message, and the DU 174 instead sends to the CU-CP 172A another DU-to-CU message (e.g., UE Context Modification Required message) including the second SDT DU configuration, after receiving the second CU-to-DU message (event 428) and/or after transmitting the second DU-to-CU message (event 430). In some alternative implementations, the CU-CP 172A can transmit the second CU-to-DU message and receive the second DU-to-CU message (or receive the alternative DU-to-CU message discussed above), before determining that the UE 102 is in data inactivity.

In response to determining to stop the SDT, the CU-CP 172A can generate a RRC release message (e.g., RRCRelease message or RRCConnectionRelease message) to stop the SDT and maintain the UE 102 in the inactive state. The CU-CP 172A can include the SDT DU configuration (if requested and received) and a SDT CU configuration in the RRC release message. The CU-CP 172A then sends 432 to the DU 174 a third CU-to-DU message (e.g., a UE Context Release Command message or a UE Context Modification Request message) that includes the RRC release message. In turn, the DU 174 transmits 434 the RRC release message to the UE 102. The UE 102 stops the SDT and remains in the inactive state, upon receiving the RRC release message. In response to or after stopping the SDT, the UE 102 may stop the SDT timer, stop monitoring a PDCCH for SDT, and/or release a C-RNTI that the UE 102 uses to monitor a PDCCH for SDT. Alternatively, the UE 102 retains the C-RNTI. In response to the third CU-to-DU message, the DU 174 can retain the SDT DU configuration and may or may not release the first non-SDT DU configuration and/or second non-SDT DU configuration discussed above in connection with FIG. 3. The DU 174 can send a third DU-to-CU message (e.g., a UE Context Release Complete message or a UE Context Modification Response message) to the CU-CP 172A in response to the third CU-to-DU message. In some implementations, if the RRC release message instructs the UE 102 to transition to the inactive state (specifically, RRC_IDLE), the UE 102 transitions to the RRC_IDLE state and releases a non-SDT configuration (e.g., the first non-SDT DU configuration, first non-SDT CU configuration, second non-SDT DU configuration, and/or second non-SDT CU configuration described for FIG. 3) and at least one SDT configuration (e.g., the first SDT DU configuration and/or first SDT CU configuration described for FIG. 3).

Examples and implementations discussed above for events 320, 321, 322, 323, 324, 326, 328, 330, 332, 334 can apply to events 420, 421, 422, 423, 424, 426, 428, 430, 432, 434, respectively. After stopping the SDT, the UE 102 can perform another small data transmission procedure with the base station 104 or base station 106, similar to the procedure 494.

In some implementations, the CU-CP 172A may not request that the DU 174 provide a SDT DU configuration. In such cases, the events 428 and 430 can omitted, and the CU-CP 172A does not include a SDT DU configuration in the RRC release message. Alternatively, the CU-CP 172A may generate the second SDT DU configuration by itself and include the second SDT DU configuration in the RRC release message.

In some implementations, the DU 174 may not include a SDT DU configuration in the second DU-to-CU message, e.g., if or because the UE 102 does not support CG-SDT, the DU 174 does not support CG-SDT, or the DU 174 does not have available radio resources for CG-SDT. In such cases, the RRC release message does not include a SDT DU configuration. Otherwise, the DU 174 can include the second SDT DU configuration as described above. In some implementations, the DU 174 may not include a CG-SDT configuration in the second SDT DU configuration in the second DU-to-CU message, e.g., if or because the UE 102 does not support CG-SDT, the DU 174 does not support CG-SDT or the DU 174 does not have available radio resources for CG-SDT. In such cases, the second SDT DU configuration does not include a CG-SDT configuration. Otherwise, the DU 174 can include the at least one CG-SDT configuration in the second SDT DU configuration as described above.

In some implementations, the CU-CP 172A may request the DU 174 to provide a SDT DU configuration as described above, in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide a SDT DU configuration. The CU-CP 172A can receive a UE capability (e.g., UE-NR-Capability IE) of the UE 102 from the UE 102, the CN 110 (e.g., MME 114 or AMF 164), or the base station 106, before the UE 102 initiated the SDT, while the UE 102 operates 402 in the inactive state, while the UE 102 performs the SDT (e.g., in the UE Context Setup Request message of the event 408 or the CU-to-DU message of the event 428), or while the UE 102 operates in the connected state as described for FIG. 3. The UE capability indicates whether the UE 102 supports CG-SDT. Thus, the CU-CP 172A can determine whether the UE 102 supports CG-SDT in accordance with the UE capability. In some implementations, the CU-CP 172A can receive from the DU 174 a DU-to-CU message indicating whether the DU 174 supports CG-SDT. The DU-to-CU message can be the second DU-to-CU message, the message of the event 308 or 316, or a non-UE associated message (e.g., a non-UE associated F1AP message defined in 3GPP specification 38.473).

In some implementations, the DU 174 may determine whether to provide a SDT DU configuration for the UE 102 to the CU-CP 172A, based on whether the UE 102 supports CG-SDT or not. In addition to whether the UE 102 supports CG-SDT or not, the DU 174 may additionally determine whether to provide a SDT DU configuration for the UE 102 to the CU-CP 172A, based on whether the DU 174 supports CG-SDT or not. In cases where the UE 102 supports CG-SDT and/or the DU 174 supports or enables CG-SDT, the DU 174 provides the second SDT DU configuration for the UE 102 to the CU-CP 172A as described above. In cases where the UE 102 does not support CG-SDT or the DU 174 does not support CG-SDT, the DU 174 does not provide a SDT DU configuration for the UE 102 (e.g., the DU 174 does not include the second SDT DU configuration in the second DU-to-CU message). The DU 174 can receive the UE capability from the CU-CP 172A, e.g., while the UE 102 operates in the connected state or in the inactive state. Thus, the DU 174 can determine whether the UE 102 supports CG-SDT in accordance with the UE capability. In some implementations, the DU 174 can send a DU-to-CU message to the CU-CP 172A to indicate whether the DU 174 supports CG-SDT, as described above.

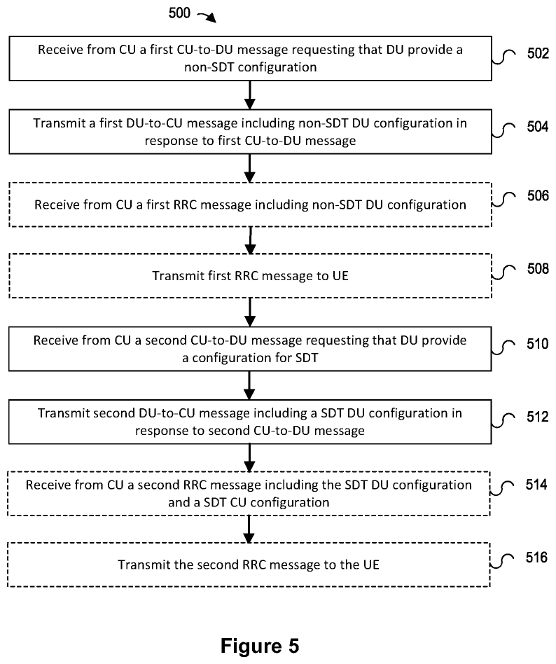

Next, several example methods, that can be implemented in the UE, in one or more base stations, DUs or CUs or in a RAN to support data communications in the inactive state, are discussed next with reference to FIGS. 5-16.

FIG. 5 illustrates a method 500, which can be implemented by a DU (e.g., the DU 174), for providing SDT configuration parameters to a UE (e.g., the UE 102) via a CU (e.g., the CU 172 or the CU-CP 172A).

The method 500 begins at block 502, where the DU receives from the CU a first CU-to-DU message requesting the DU to provide non-SDT configuration parameters (e.g., event 306). At block 504, the DU transmits a first DU-to-CU message including a non-SDT DU configuration from the DU in response to the first CU-to-DU message (e.g., event 308). At block 506, the DU receives from the CU a first RRC message including the non-SDT DU configuration (e.g., event 310). At block 508, the DU transmits the first RRC message to the UE (e.g., event 312). At block 510, the DU receives from a CU a second CU-to-DU message requesting the DU to provide configuration parameters for SDT (e.g., event 328). At block 512, the DU transmits a second DU-to-CU message including a SDT DU configuration from the DU in response to the second CU-to-DU message (e.g., event 330). At block 514, the DU receives from the CU a second RRC message including the SDT DU configuration and a SDT CU configuration (e.g., event 332). At block 516, the DU transmits the second RRC message to the UE (e.g., event 334).

In some implementations, the CU can include a first SDT request indication in the second CU-to-DU message. In response to the first SDT request indication, the DU includes one or more configurations for operations of MAC protocol layer (e.g., NR MAC 204B) and/or PHY protocol layer (e.g., NR MAC 202B) in the SDT DU configuration (e.g., SDT-MAC-PHY-Config IE). For example, the one or more configurations include a BSR configuration (e.g., BSR-Config) and/or a PHR configuration (e.g., PHR-Config). In some implementations, the first SDT request indication can be common for CG-SDT and RA-SDT. The DU can include a common SDT configuration (e.g., as described above) in the SDT DU configuration in response to the first SDT request indication. The DU can determine whether to include a CG-SDT configuration in the SDT DU configuration as described for FIGS. 3 and 4, in response to the first SDT request indication. Alternatively, the CU can include a second SDT request indication, which is specific for CG-SDT, in the second CU-to-DU message. In response to the second SDT indication, the DU can include a CG-SDT configuration in the SDT DU configuration as described above. In cases where the CU does not include the second SDT request indication, the DU does not include a CG-SDT configuration in the SDT DU configuration.

Alternatively, the first SDT request indication can be specific for RA-SDT. In this case, the DU can include a RA-SDT configuration (e.g., as described above) in the SDT DU configuration in response to the first SDT request indication. In some implementations, the CU can include the second SDT request indication, which is specific for CG-SDT, in the second CU-to-DU message. In response to the second SDT request indication, the DU includes a CG-SDT configuration in the SDT DU configuration. In cases where the CU does not include the second SDT request indication, the DU does not include a CG-SDT configuration in the SDT DU configuration.

In some implementations, the DU can directly include the one or more configurations and/or the CG-SDT configuration in the second DU-to-CU message without using the SDT DU configuration as a container IE. In such cases, the CU can generate a container IE (e.g., SDT-Config IE or SDT-MAC-PHY-Config IE) including the one or more configurations and/or the CG-SDT configuration.

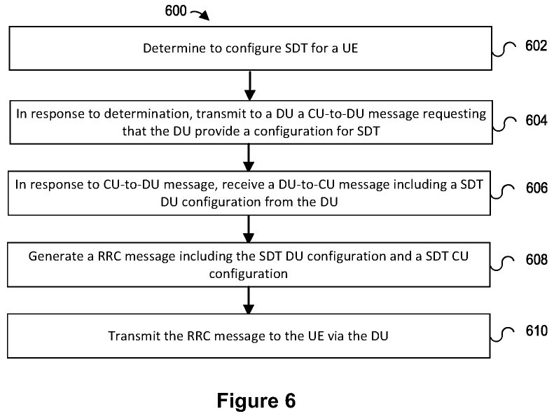

FIG. 6 illustrates a method 600, which can be implemented by a CU (e.g., the CU 172 or CU-CP 172A), for providing SDT configuration parameters to a UE (e.g., the UE 102) via a DU (e.g., the DU 174).

The method 600 begins at block 602, where the CU determines to configure SDT for the UE. At block 604, the CU transmits to the DU a CU-to-DU message requesting the DU to provide configuration parameters for SDT in response to the determination (e.g., events 328, 428). At block 606, the CU receives a DU-to-CU message including a SDT DU configuration from the DU in response to the CU-to-DU message (e.g., events 330, 430). At block 608, the CU generates a RRC message including the SDT DU configuration and a SDT CU configuration. At block 610, the CU transmits the RRC message to the UE via the DU (e.g., events 332, 334, 432, 434).

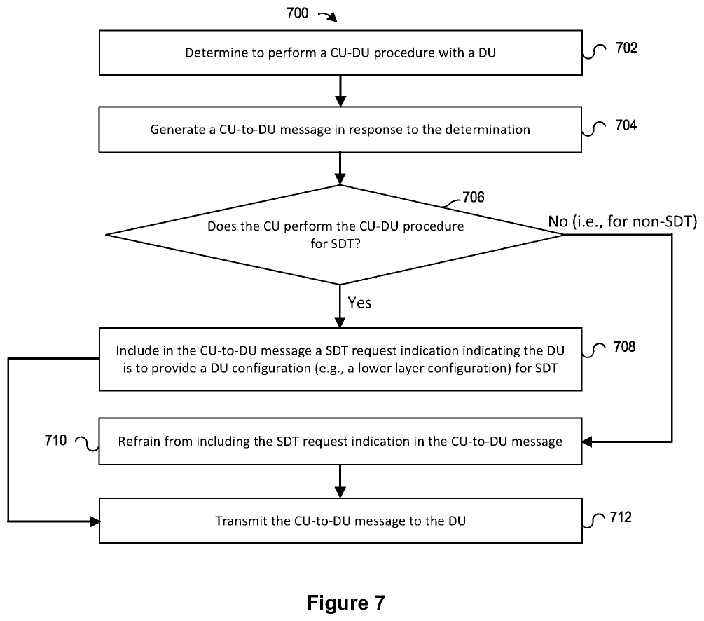

FIG. 7 illustrates a method 700, which can be implemented by a CU (e.g., the CU 172 or CU-CP 172A), for requesting SDT configuration parameters for a UE (e.g., the UE 102) from a DU (e.g., the DU 174).

The method 700 begins at block 702, where the CU determines to perform a CU-DU procedure with the DU (e.g., events 306 and 308, 328 and 330, or 428 and 430). At block 704, the CU generates a CU-to-DU message in response to the determination (e.g., events 306, 328, 428). At block 706, the CU determines whether the CU performs the CU-DU procedure for SDT. When the CU determines the CU performs the CU-DU procedure for SDT, the flow proceeds to block 708. At block 708, the CU includes a SDT request indication indicating the DU to provide a DU configuration (e.g., a lower layer configuration) for SDT in the CU-to-DU message (e.g., events 328, 428). Otherwise, when the CU determines the CU performs the CU-DU procedure for non-SDT, the flow proceeds to block 710. At block 710, the CU refrains from including the SDT request indication in the CU-to-DU message (e.g., events 306). The flow proceeds to block 712 from block 710 as well as from block 708. At block 712, the CU transmits the CU-to-DU message to the DU (e.g., events 306, 328, 428).

In some implementations, the CU-DU procedure can be a UE Context Modification procedure.

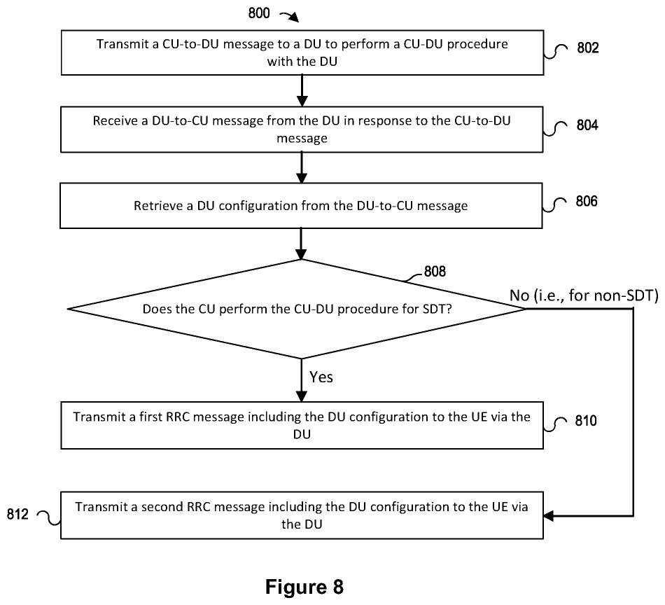

FIG. 8 illustrates a method 800, which can be implemented by a CU (e.g., the CU 172 or the CU-CP 172A), for providing SDT configuration parameters to a UE (e.g., the UE 102) via a DU (e.g., the DU 174).

The method 800 begins at block 802, where the CU transmits a CU-to-DU message to the DU to perform a CU-DU procedure with the DU (e.g., events 306, 328, 428). At block 804, the CU receives a DU-to-CU message from the DU in response to the CU-to-DU message (e.g., event 308, 330, 430). At block 806, the CU retrieves a DU configuration from the DU-to-CU message. At block 808, the CU determines whether the CU performs the CU-DU procedure for SDT. When the CU determines the CU performs the CU-DU procedure for SDT, the flow proceeds to block 810. At block 810, the CU transmits a first RRC message including the DU configuration to the UE via the DU (e.g., event 332, 334, 432, 434). Otherwise, when the CU determines that the CU performs the CU-DU procedure for non-SDT, the flow proceeds to block 812. At block 812, the CU transmits a second RRC message including the DU configuration to the UE via the DU (e.g., event 312).

In some implementations, the CU-DU procedure can be a UE Context Modification procedure. In some implementations, the first RRC message and the second RRC message can be a RRC release message and a RRC reconfiguration message, respectively.

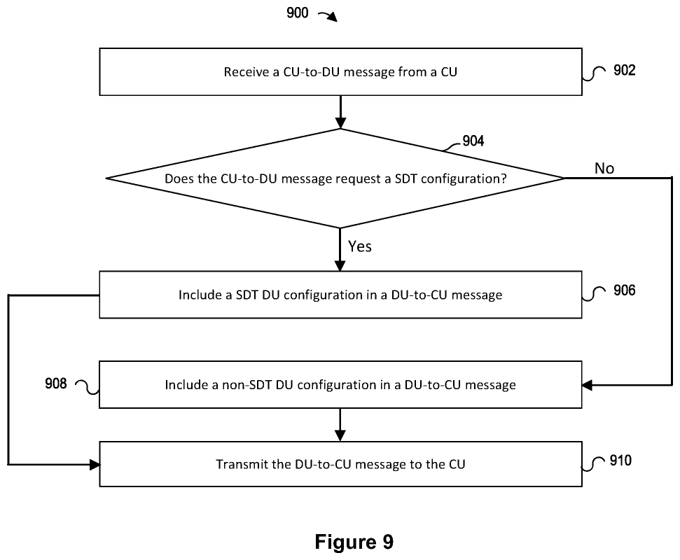

FIG. 9 illustrates a method 900, which can be implemented by a DU (e.g., the DU 174), for providing SDT or non-SDT configuration parameters for a UE (e.g., the UE 102) to a CU (e.g., the CU 172 or the CU-CP 172A).

The method 900 begins at block 902, where the DU receives a CU-to-DU message from a CU (e.g., events 306, 328, 428). At block 904, the DU determines whether the CU-to-DU message requests a SDT configuration. When the DU determines the CU-to-DU message requests a SDT configuration, the flow proceeds to block 906. At block 906, the DU includes a SDT DU configuration in a DU-to-CU message (e.g., 330, 430). Otherwise, when the DU determines the CU-to-DU message does not request a SDT configuration, the flow proceeds to block 908. At block 908, the DU includes a non-SDT DU configuration in a DU-to-CU message (see e.g., event 308). The flow proceeds to block 910 from block 908 as well as from block 906. At block 910, the DU transmits the DU-to-CU message to the CU (e.g., 308, 330, 430).

In some implementations, the DU at block 908 refrains from including a SDT DU configuration in the DU-to-CU message.

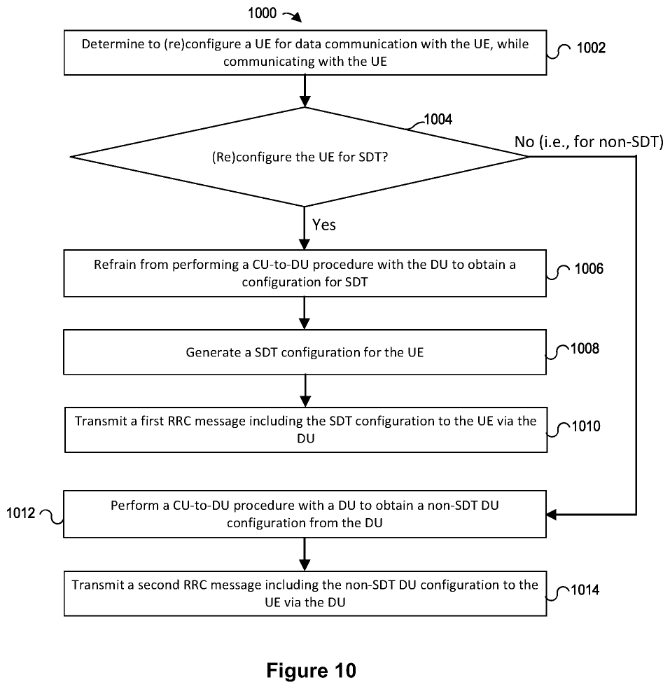

FIG. 10 illustrates a method 1000, which can be implemented by a CU (e.g., the CU 172 or the CU-CP 172A), for providing SDT or non-SDT configuration parameters to a UE (e.g., the UE 102) via a DU (e.g., the DU 174).

The method 1000 begins at block 1002, where the CU determines to (re) configure a UE for data communication with the UE, while communicating with the UE. At block 1004, the CU determines whether the CU (re) configures the UE for SDT (e.g., RA-SDT). When the CU determines to (re) configure the UE for SDT, the flow proceeds to block 1006. At block 1006, the CU refrains from performing a CU-to-DU procedure with the DU to obtain a configuration for SDT (e.g., because the CU may not need a DU configuration to configure RA-SDT operation). At block 1008, the CU generates a SDT configuration for the UE. At block 1010, the CU transmits a first RRC message including the SDT configuration to the UE via the DU. Otherwise, when the CU determines to (re) configure the UE for non-SDT at block 1004, the flow proceeds to block 1012. At block 1012, the CU performs a CU-to-DU procedure with a DU to obtain a non-SDT DU configuration from the DU (e.g., events 328, 330, 428, 430). At block 1014, the CU transmits a second RRC message including the non-SDT DU configuration to the UE via the DU (e.g., events 332, 334, 432, 434).

In some implementations, the CU-to-DU procedure can be a UE Context Modification procedure. In some implementations, the first RRC message and the second RRC message can be a RRC release message and a RRC reconfiguration message, respectively. In some implementations, the SDT configuration discussed above for the method 1000 can include a SDT CU configuration and/or a SDT DU configuration as described above.

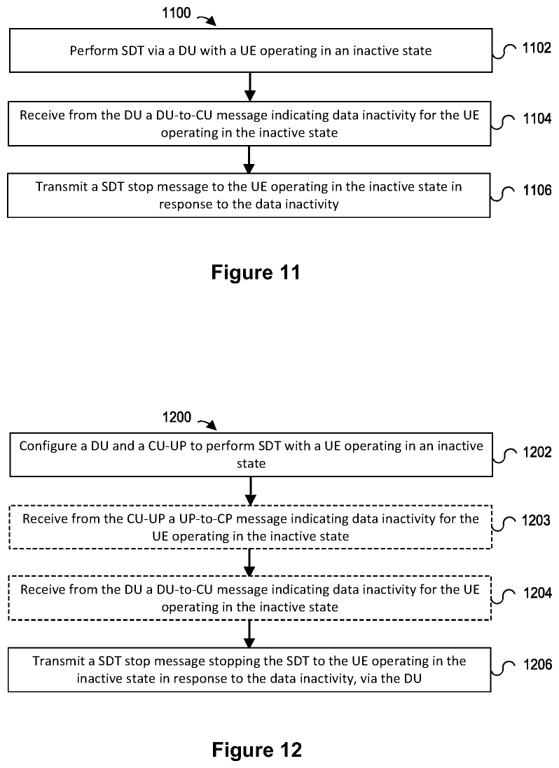

FIG. 11 illustrates a method 1100, which can be implemented by a CU (e.g., the CU 172), for stopping SDT for a UE (e.g., the UE 102) via a DU (e.g., the DU 174). The method 1100 begins at block 1102, where the CU performs SDT via the DU with a UE operating in an inactive state (e.g., events 404, 406, 415, 416, 418). At block 1104, the CU receives from the DU a DU-to-CU message indicating data inactivity for the UE operating in the inactive state (e.g., events 421, 422). At block 1106, the CU transmits a SDT stop message (e.g., a RRC release message) to the UE operating in the inactive state in response to the data inactivity (e.g., events 432, 434).

FIG. 12 illustrates a method 1200, which can be implemented by a CU-CP (e.g., the CU-CP 172A), for stopping SDT for a UE (e.g., the UE 102) via a DU (e.g., the DU 174). The method 1200 begins at block 1202, where the CU-CP configures the DU and a CU-UP (e.g., the CU-UP 172B) to perform SDT with a UE operating in an inactive state. At block 1203, the CU-CP receives from the CU-UP a UP-to-CP message indicating data inactivity for the UE operating in the inactive state (e.g., event 423). At block 1204, the CU-CP can optionally receive from the DU a DU-to-CU message indicating data inactivity for the UE operating in the inactive state (e.g., events 421, 422). At block 1206, the CU-CP transmits, to the UE operating in the inactive state via the DU, a SDT stop message stopping the SDT in response to the data inactivity of the UP-to-CP message and/or the DU-to-CU message (e.g., events 432, 434).

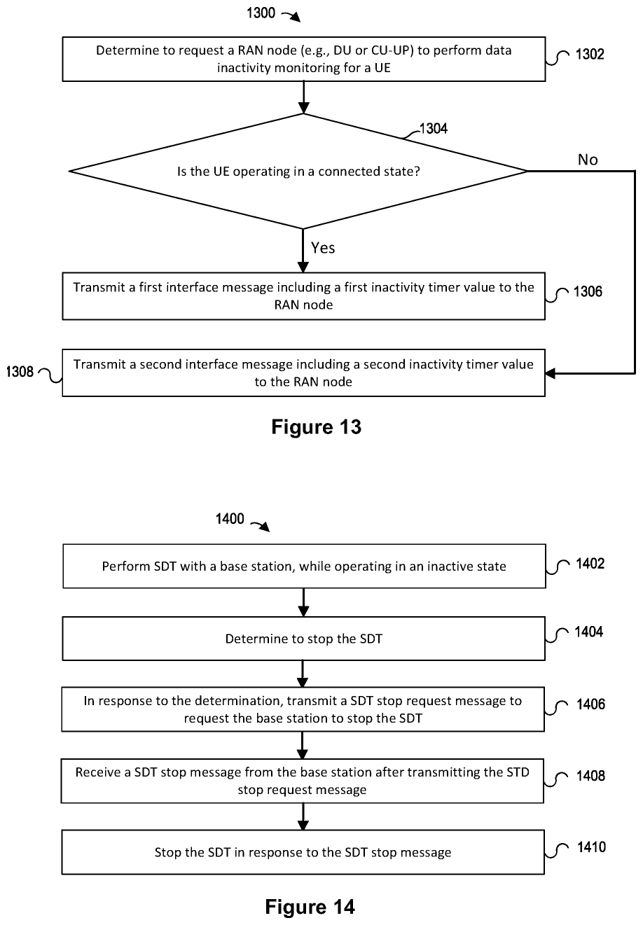

FIG. 13 illustrates a method 1300, which can be implemented by a CU (e.g., the CU 172), for enabling data inactivity monitoring for a UE (e.g., the UE 102) at a RAN node such as a DU (e.g., the DU 174) or a CU-UP (e.g., the CU-UP 172B). The method 1300 begins at block 1302, where the CU determines to request the RAN node to perform data inactivity monitoring for a UE. At block 1304, the CU determines whether the UE is operating in a connected state. When the CU determines that UE is operating in the connected state, the flow proceeds to block 1306. At block 1306, the CU transmits a first interface message including a first inactivity timer value to the RAN node. Otherwise, when the CU determines that the UE is not operating in the connected state (e.g., the UE is operating in an inactive state), the flow proceeds to block 1308. At block 1308, the CU transmits a second interface message including a second inactivity timer value to the RAN node.

In some implementations, the RAN node performs data inactivity monitoring for the UE in accordance with the first or second inactivity timer value received from the CU. In cases where the RAN node continuously detects data inactivity for the UE for the first or second inactivity timer value, the RAN node can send an inactivity notification to the CU to indicate that the UE is in data inactivity (e.g., events 322, 323, 422, 423). In some implementations, the RAN node can start an inactivity timer with the first or second inactivity timer value. If the RAN node detects data activity for the UE during the inactivity timer running, the RAN node can restart the inactivity timer. If the inactivity timer expires, the RAN node can sent the inactivity notification to the CU.

In cases where the RAN node is a DU, the first and second interface messages can be CU-to-DU messages. For example, the CU-to-DU messages can be F1 application protocol (F1AP) messages. In another example, the CU-to-DU messages can be UE Context Setup Request messages or UE Context Modification Request messages. In cases where the RAN node is a CU-UP, the first and second interfaces message can be CP-to-UP messages. For example, the CP-to-UP messages can be E1 application protocol (E1AP) messages. In another example, the CP-to-UP message can be Bearer Context Setup Request messages or Bearer Context Modification Request messages.

The UE in the inactive state usually has less data to send while performing SDT, compared to the case. Thus, the CU can set the second inactivity timer value smaller than the first inactivity timer value. In some implementations, the CU can set the first inactivity timer value based on UE assistance information received from the UE (e.g., events 320, 321). Alternatively, the CU set the first inactivity timer value to a predetermined or preconfigured timer value. In some implementations, the CU can set the second inactivity timer value based on UE assistance information received from the UE (e.g., events 420, 421). Alternatively, the CU set the second inactivity timer value to a predetermined or preconfigured timer value.

FIG. 14 illustrates a method 1400, which can be implemented by a UE (e.g., the UE 102), for stopping SDT with a base station (e.g., the base station 104).

The method 1400 begins at block 1402, where the UE performs SDT with the base station, while operating in an inactive state (e.g., events 404, 406, 418). At block 1404, the UE determines to stop the SDT. At block 1406, the UE transmits a SDT stop request message to request the base station to stop the SDT in response to the determination (e.g., event 420). At block 1408, the UE receives a SDT stop message from the base station after transmitting the message (e.g., event 434). At block 1410, the UE stops the SDT in response to the SDT stop message.

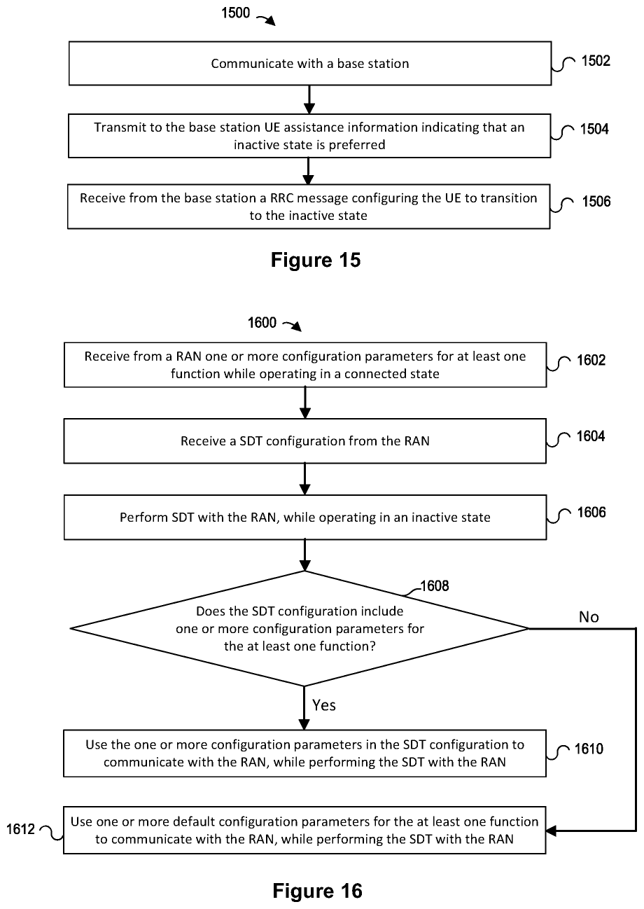

FIG. 15 illustrates a method 1500, which can be implemented by a UE (e.g., the UE 102), for stopping SDT with a base station (e.g., the base station 104).

The method 1500 begins at block 1502, where the UE communicates with a base station (e.g., events 304, 318, 404, 418). At block 1504, the UE transmits assistance information indicating that an inactive state is preferred to the base station (e.g., event 320, 420). At block 1506, the UE receives from the base station a RRC message configuring the UE to transition to the inactive state (e.g., events 334, 434).

In some implementations, the UE can indicate that the inactive state with SDT configured is preferred in the assistance information. In other implementations, the UE can indicate that the inactive state without SDT configured is preferred in the assistance information. In some implementations, the UE can indicate that the inactive state with or without SDT configured is preferred in the assistance information, based on data inactivity status of the UE. For example, the UE can monitor data activity status of the UE and determine the data activity status with different levels indicating different data activity status (e.g., level X is heavy data activity, level Y is light data activity, level Z is no data activity). In the case of level Y, the UE can indicate that the inactive state with SDT configured is preferred in the assistance information. In the case of level Z, the UE can indicate that the inactive state without SDT configured is preferred in the assistance information. Alternatively, in the case of level Z, the UE can instead indicate that an idle state is preferred in the assistance information. In the case of level X, the UE refrains from sending the base station assistance information indicating that the inactive or idle state is preferred.

In other implementations, the UE can indicate that the inactive state with or without SDT configured is preferred in the assistance information, based on whether one or more applications of the UE is/are active. For example, when a first application of the UE is active, the UE refrains from sending the base station assistance information indicating that the inactive or idle state is preferred. When the first application is not active, the UE can indicate that the inactive or idle state is preferred in the assistance information. In some further implementations, when the UE first application is not active and a second application is active, the UE can indicate that the inactive state with SDT is preferred in the assistance information. When the UE first application is not active and a second application is not active, the UE can indicate that the inactive state without SDT or the idle state is preferred in the assistance information.

As seen from the preceding description, in both the method 1400 of FIG. 14 and the method 1500 of FIG. 15, the UE can communicate with a base station (block 1402 or 1502), transmit to the base station a request or preference for a particular mode of SDT operation (block 1406 or 1504), and receive from the base station a message that causes the UE to change to the requested or preferred mode of SDT operation (block 1408 or 1506).

FIG. 16 illustrates a method 1600, which can be implemented by a UE (e.g., the UE 102), for performing SDT with a base station (e.g., the base station 104).

The method 1600 begins at block 1602, where the UE receives one or more configuration parameters for at least one function of a RAN while operating in a connected state (e.g., events 304, 312). At block 1604, the UE receives a SDT configuration from the RAN (e.g., events 334, 434). At block 1606, the UE performs SDT with the RAN, while operating in an inactive state (e.g., events 404, 418). At block 1608, the UE determines whether the SDT configuration includes one or more configuration parameters for the at least one function. When the UE determines the SDT configuration includes one or more configuration parameters for the at least one function, the flow proceeds to block 1610. At block 1610, the UE uses one or more configuration parameters in the SDT configuration to communicate with the RAN, while performing the SDT with the RAN (e.g., events 404, 418). Otherwise, when the UE determines the SDT configuration does not include one or more configuration parameters for the at least one particular function, the flow proceeds to block 1612. At block 1612, the UE uses one or more default configuration parameters for the at least one function to communicate with the RAN, while performing the SDT with the RAN (e.g., events 404, 418). In some implementations, the one or more default configuration parameters with default value(s) can be defined in a 3GPP specification (e.g., 38.331). In an alternative implementation not shown in FIG. 16, the UE at block 1612 instead uses the one or more configuration parameters received at block 1602 to communicate with the RAN, rather than default configuration parameters. The configuration parameter(s) may be from a CellGroupConfig IE that the RAN provided at block 1602, for example.

In some implementations, the at least one function includes a MAC-layer function, such as a buffer status report (BSR) function and/or a power headroom report (PHR) function. While performing SDT with the RAN, the UE in some implementations refrains from using the one or more configuration parameters received at block 1602. During SDT (i.e., events 404, 418), the UE can use other configuration parameters to communicate with the RAN. The UE receives the other configuration parameters before receiving the SDT configuration.

The following list of examples reflects a variety of the implementations explicitly contemplated by the present disclosure:

Example 1. A method, implemented by a distributed unit (DU) of a base station that also includes a central unit (CU), of handling small data transmission (SDT) with a user equipment (UE), the method comprising: communicating, by processing hardware of the DU, with the UE in accordance with a first DU configuration; receiving, by the processing hardware and from the CU, a CU-to-DU message requesting a SDT DU configuration for the UE; and transmitting, by the processing hardware, a SDT DU configuration to the UE.

Example 2. The method of example 1, further comprising: after the transmitting SDT DU configuration to the UE, communicating, by the processing hardware, with the UE in accordance with the SDT DU configuration.

Example 3. The method of example 1 or 2, wherein the CU-to-DU message is a first CU-to-DU message, and wherein the method further comprises: in response to receiving the first CU-to-DU message, transmitting, by the processing hardware, a DU-to-CU message including the SDT DU configuration to the CU; and receiving, by the processing hardware and from the CU, a second CU-to-DU message including the SDT DU configuration and a SDT CU configuration.

Example 4. The method of example 3, wherein transmitting the SDT DU configuration to the UE includes transmitting the SDT DU configuration and the SDT CU configuration to the UE.

Example 5. The method of example 4, wherein transmitting the SDT DU configuration and the SDT CU configuration to the UE includes transmitting the SDT DU configuration and the SDT CU configuration to the UE in a radio resource control (RRC) release message.

Example 6. The method of any one of examples 3-5, wherein the first CU-to-DU message is a UE context modification request message and the DU-to-CU message is a UE context modification response message.

Example 7. The method of any one of examples 1-6, wherein: the first DU configuration is a non-SDT DU configuration; and communicating with the UE, receiving the CU-to-DU message, and transmitting the SDT DU configuration to the UE occur while the UE is in a connected state.

Example 8. The method of any one of examples 1-6, wherein: the SDT DU configuration is a second SDT DU configuration; the first DU configuration is a first SDT DU configuration; and communicating with the UE, receiving the CU-to-DU message, and transmitting the second SDT DU configuration to the UE occur while the UE is in an inactive state.

Example 9. The method of any one of examples 1-8, further comprising: while communicating with the UE in accordance with the first DU configuration, monitoring, by the processing hardware, for data inactivity of the UE; detecting, by the processing hardware, data inactivity of the UE; and transmitting, by the processing hardware, an indication of UE data inactivity to the CU, wherein receiving the CU-to-DU message requesting the SDT DU configuration for the UE occurs after transmitting the indication of UE data inactivity to the CU.

Example 10. The method of example 9, further comprising: before monitoring for data inactivity of the UE, receiving, by the processing hardware, a message from the CU requesting that the DU perform the monitoring.

Example 11. The method of example 9 or 10, further comprising: receiving, by the processing hardware, an inactivity timer value from the CU, wherein monitoring for data inactivity of the UE includes monitoring for data inactivity of the UE in accordance with the inactivity timer value.

Example 12. The method of example 11, wherein either: receiving the inactivity timer value occurs while the UE is in a connected state, and the inactivity timer value is a timer value that is specific to the connected state; or receiving the inactivity timer value occurs while the UE is in an inactive state, and the inactivity timer value is a timer value that is different than the timer value specific to the connected state.

Example 13. The method of any one of examples 1-8, further comprising: receiving, by the processing hardware and from the UE, information indicating data inactivity of the UE; and transmitting, by the processing hardware, an indication of UE data inactivity to the CU, wherein receiving the CU-to-DU message requesting the SDT DU configuration for the UE occurs after transmitting the indication of UE data inactivity to the CU.

Example 14. A method, implemented by a central unit (CU) of a base station that also includes a distributed unit (DU), of handling small data transmission (SDT) with a user equipment (UE), the method comprising: communicating, by processing hardware of the CU, with the UE via the DU and in accordance with a first CU configuration; transmitting, by the processing hardware and to the DU, a CU-to-DU message requesting a SDT DU configuration for the UE; and receiving, by the processing hardware, a DU-to-CU message including the SDT DU configuration from the DU.

Example 15. The method of example 14, wherein the CU-to-DU message is a first CU-to-DU message, and wherein the method further comprises: after receiving the DU-to-CU message, transmitting, by the processing hardware and to the DU, a second CU-to-DU message including the SDT DU configuration and a SDT CU configuration.

Example 16. The method of example 15, further comprising: after the transmitting the second CU-to-DU message to the UE, communicating, by the processing hardware, with the UE via the DU and in accordance with the SDT CU configuration.

Example 17. The method of any one of examples 14-16, wherein the CU-to-DU message is a UE context modification request message and the DU-to-CU message is a UE context modification response message.

Example 18. The method of any one of examples 15-17, wherein: the first CU configuration is a non-SDT CU configuration; and communicating with the UE via the DU, transmitting the CU-to-DU message, and receiving the DU-to-CU message including the SDT DU configuration occur while the UE is in a connected state.

Example 19. The method of any one of examples 15-17, wherein: the SDT CU configuration is a second SDT CU configuration; the first CU configuration is a first SDT CU configuration; and communicating with the UE via the DU, transmitting the CU-to-DU message, and receiving the DU-to-CU message including the SDT DU configuration occur while the UE is in an inactive state.

Example 20. The method of any one of examples 14-19, further comprising: while communicating with the UE via the DU in accordance with the first CU configuration, monitoring, by a user plane of the CU (CU-UP), for data inactivity of the UE; detecting, by the CU-UP, data inactivity of the UE; and transmitting, by the processing hardware, an indication of UE data inactivity to a control plane of the CU (CU-CP), wherein transmitting the CU-to-DU message requesting the SDT DU configuration to the DU occurs after transmitting the indication of UE data inactivity to the CU-UP.

Example 21. The method of any one of examples 14-19, further comprising: receiving, by the processing hardware, an indication of UE data inactivity from the DU, wherein transmitting the CU-to-DU message requesting the SDT DU configuration for the UE occurs after receiving the indication of UE data inactivity from the DU.

Example 22. The method of example 21, further comprising: transmitting, by the processing hardware, a message to the DU requesting that the DU perform UE data inactivity monitoring.

Example 23. The method of example 21 or 22, further comprising: transmitting, by the processing hardware, an inactivity timer value to the DU for use in UE data inactivity monitoring.

Example 24. The method of example 21, wherein receiving the indication of UE data inactivity includes receiving, from the UE via the DU, UE assistance information that includes the indication of UE data inactivity.

Example 25. A method, implemented by a central unit (CU) of a base station that also includes a distributed unit (DU), of handling small data transmission (SDT) with a user equipment (UE), the method comprising: communicating, by processing hardware of the CU, with the UE via the DU and in accordance with a first configuration; determining, by the processing hardware, to configure or reconfigure the UE for SDT; generating, by the processing hardware, a SDT configuration; and transmitting, by the processing hardware, the SDT configuration to the UE via the DU.

Example 26. The method of example 25, wherein: the SDT configuration includes a SDT CU configuration and/or a SDT DU configuration.

Example 27. The method of example 25 or 26, wherein: the determining includes determining to configure or reconfigure the UE for random access SDT (RA-SDT); and the SDT configuration includes only the SDT CU configuration.

Example 28. The method of any one of examples 25-27, wherein: the first configuration is a non-SDT configuration; and the communicating, the determining, the generating, and the transmitting occur while the UE is in a connected state.

Example 29. The method of any one of examples 25-27, wherein: the SDT configuration is a second SDT configuration; the first configuration is a first SDT configuration; and the communicating, the determining, the generating, and the transmitting occur while the UE is in an inactive state.

Example 30. The method of any one of examples 25-29, further comprising: while communicating with the UE via the DU in accordance with the first configuration, monitoring, by a user plane of the CU (CU-UP), for data inactivity of the UE; detecting, by the CU-UP, data inactivity of the UE; and transmitting, by the processing hardware, an indication of UE data inactivity to a control plane of the CU (CU-CP), wherein transmitting the SDT configuration to the UE via the DU occurs after transmitting the indication of UE data inactivity to the CU-UP.

Example 31. The method of any one of examples 25-30, further comprising: receiving, by the processing hardware, an indication of UE data inactivity from the DU, wherein transmitting the SDT configuration to the UE via the DU occurs after receiving the indication of UE data inactivity from the DU.

Example 32. The method of example 31, further comprising: transmitting, by the processing hardware, a message to the DU requesting that the DU perform UE data inactivity monitoring.

Example 33. The method of example 31 or 32, further comprising: transmitting, by the processing hardware, an inactivity timer value to the DU for use in UE data inactivity monitoring.

Example 34. The method of example 31, wherein receiving the indication of UE data inactivity includes receiving, from the UE via the DU, UE assistance information that includes the indication of UE data inactivity.

Example 35. A radio access network (RAN) node comprising processing hardware and configured to perform the method of any one of examples 1-34.

Example 36. A method, implemented by a user equipment (UE), of handling small data transmission (SDT) with a base station, the method comprising: communicating, by processing hardware of the UE, with the base station; transmitting, by the processing hardware, a request or preference for a mode of SDT operation to the base station; and receiving, by the processing hardware, a message from the base station that causes the UE to change to the requested or preferred mode of SDT operation.

Example 37. The method of example 36, wherein: the communicating includes performing SDT with the base station while the UE is in an inactive state; the transmitting includes transmitting a SDT stop request message to the base station; the receiving includes receiving a SDT stop message from the base station; and the method further comprises stopping, by the processing hardware and in response to the SDT stop message, the SDT with the base station.

Example 38. The method of example 36, wherein: the transmitting includes transmitting a preference for (i) a UE inactive state with SDT configured, or (ii) a UE inactive state without SDT configured.

Example 39. The method of example 38, further comprising: determining, by the processing hardware, data activity status of the UE, wherein transmitting the preference includes transmitting a preference for the UE inactive state without SDT configured based on the data activity status.

Example 40. The method of example 38, wherein transmitting the preference includes transmitting a preference for the UE inactive state with SDT configured based on a first application of the UE being inactive.

Example 41. The method of example 40, wherein transmitting the preference includes transmitting the preference for the UE inactive state with SDT configured based on the first application of the UE being inactive and a second application of the UE being active.

Example 42. The method of example 38, wherein transmitting the preference includes transmitting a preference for the UE inactive state without SDT configured based on a particular plurality of applications of the UE being inactive.

Example 43. A user equipment (UE) comprising processing hardware and configured to perform the method of any one of examples 36-42.

Example 44. A method, implemented by a base station, of handling small data transmission (SDT) with a user equipment (UE), the method comprising: communicating, by processing hardware of the base station, with the UE; receiving, by the processing hardware, a request or preference for a mode of SDT operation from the UE; and transmitting, by the processing hardware, a message to the UE that causes the UE to change to the requested or preferred mode of SDT operation.

Example 45. The method of example 44, wherein: the communicating includes performing SDT with the UE while the UE is in an inactive state; the receiving includes receiving a SDT stop request message from the UE; and the transmitting includes transmitting a SDT stop message to the UE.

Example 46. The method of example 44, wherein: the receiving includes receiving a preference for (i) a UE inactive state with SDT configured, or (ii) a UE inactive state without SDT configured.

Example 47. A base station comprising processing hardware and configured to perform the method of any one of examples 44-46.

Example 48. A method, implemented by a user equipment (UE), of handling small data transmission (SDT) with a radio access network (RAN), the method comprising: receiving, by processing hardware of the UE, a SDT configuration from the RAN; performing, by the processing hardware, SDT with the RAN in accordance with the SDT configuration; determining, by the processing hardware, that the SDT configuration does not include one or more configuration parameters for performing at least one function; and using, by the processing hardware and while performing the SDT with the RAN, one or more other configuration parameters that are not included in the SDT configuration to perform the at least one function.

Example 49. The method of example 48, further comprising: before performing the SDT with the RAN, receiving, by the processing hardware, at least one configuration parameter from the RAN while the UE is operating in a connected state, wherein using the one or more other configuration parameters includes using the at least one configuration parameter to perform the at least one function.

Example 50. The method of example 49, wherein receiving the at least one configuration parameter includes receiving a CellGroupConfig information element that includes the at least one configuration parameter.

Example 51. The method of example 48, wherein using the one or more other configuration parameters includes using one or more default configuration parameters.

Example 52. The method of any one of examples 48-51, wherein the at least one function includes at least one medium access control (MAC)-layer function.

Example 53. The method of example 52, wherein the at least one MAC-layer function includes a buffer status report (BSR) function and/or a power headroom report (PHR) function.

Example 54. A user equipment (UE) comprising processing hardware and configured to perform the method of any one of examples 48-53.

The following description may be applied to the description above.

In some implementations, a “message” (as the term is used above) can be replaced by “information element (IE),” and vice versa. In some implementations, an “IE” (as the term is used above) can be replaced by “field,” and vice versa. In some implementations, a “configuration” (as the term is used above) can be replaced by “configurations” or “configuration parameters,” and vice versa. In some implementations, “small data transmission” (as the term is used above) can be replaced by “early data transmission” (and “SDT” can be replaced by “EDT”), and vice versa. In some implementations, “small data transmission” (as the term is used above) can be replaced by “small data communication,” and vice versa. In some implementations, “stop” (as the term is used above) can be replaced by “suspend.”

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method, implemented by a distributed unit (DU) of a base station that also includes a central unit (CU), of handling small data transmission (SDT) with a user equipment (UE), the method comprising:
communicating with the UE in accordance with a first DU configuration;
while communicating with the UE in accordance with the first DU configuration, determining that there is data inactivity of the UE;
transmitting an indication of UE data inactivity to the CU;
after transmitting the indication of UE data inactivity to the CU, receiving, from the CU, a CU-to-DU message requesting a SDT DU configuration for the UE; and
transmitting the SDT DU configuration to the UE.

2. The method of claim 1, further comprising:
after transmitting the SDT DU configuration to the UE, communicating with the UE in accordance with the SDT DU configuration.

3. The method of claim 1, wherein the CU-to-DU message is a first CU-to-DU message, and wherein the method further comprises:
in response to receiving the first CU-to-DU message, transmitting a DU-to-CU message including the SDT DU configuration to the CU; and
receiving, from the CU, a second CU-to-DU message including the SDT DU configuration and a SDT CU configuration,
wherein transmitting the SDT DU configuration to the UE includes transmitting the SDT DU configuration and the SDT CU configuration to the UE.

4. The method of claim 3, wherein the first CU-to-DU message is a UE context modification request message and the DU-to-CU message is a UE context modification response message.

5. The method of claim 1, wherein determining that there is data inactivity for the UE includes:
while communicating with the UE in accordance with the first DU configuration, monitoring for data inactivity of the UE; and
detecting data inactivity of the UE.

6. The method of claim 5, further comprising:
before monitoring for data inactivity of the UE, receiving a message from the CU requesting that the DU perform the monitoring; and
receiving an inactivity timer value from the CU,
wherein monitoring for data inactivity of the UE includes monitoring for data inactivity of the UE in accordance with the inactivity timer value.

7. The method of claim 1, wherein determining that there is data inactivity for the UE includes receiving, from the UE, information indicating data inactivity of the UE.

8. A method, implemented by a central unit (CU) of a base station that also includes a distributed unit (DU), of handling small data transmission (SDT) with a user equipment (UE), the method comprising:
communicating with the UE via the DU and in accordance with a first CU configuration;
while communicating with the UE via the DU in accordance with the first CU configuration, determining, by a user plane of the CU (CU-UP), that there is data inactivity of the UE;
transmitting an indication of UE data inactivity to a control plane of the CU (CU-CP);
after transmitting the indication of UE data inactivity to the CU-CP, transmitting, to the DU, a CU-to-DU message requesting a SDT DU configuration for the UE; and
receiving a DU-to-CU message including the SDT DU configuration from the DU.

9. The method of claim 8, wherein the CU-to-DU message is a first CU-to-DU message, and wherein the method further comprises:
after receiving the DU-to-CU message, transmitting, to the DU, a second CU-to-DU message including the SDT DU configuration and a SDT CU configuration.

10. The method of claim 9, further comprising:
after transmitting the second CU-to-DU message to the UE, communicating with the UE via the DU and in accordance with the SDT CU configuration.

11. The method of claim 8, wherein the CU-to-DU message is a UE context modification request message and the DU-to-CU message is a UE context modification response message.

12. The method of claim 8, wherein determining that there is data inactivity of the UE includes:
while communicating with the UE via the DU in accordance with the first CU configuration, monitoring, by a user plane of the CU (CU-UP), for data inactivity of the UE; and
detecting, by the CU-UP, data inactivity of the UE.

13. The method of claim 8, wherein determining that there is data inactivity of the UE includes:
receiving an indication of UE data inactivity from the DU,
wherein transmitting the CU-to-DU message requesting the SDT DU configuration for the UE occurs after receiving the indication of UE data inactivity from the DU.

14. The method of claim 13, further comprising:
transmitting a message to the DU requesting that the DU perform UE data inactivity monitoring; and
transmitting an inactivity timer value to the DU for use in UE data inactivity monitoring.

15. A distributed unit (DU) of a base station that also includes a central unit (CU), the DU comprising processing hardware and being configured to;
communicate with a user equipment (UE) in accordance with a first DU configuration;
while communicating with the UE in accordance with the first DU configuration, determine that there is data inactivity of the UE;
transmit an indication of UE data inactivity to the CU;
after transmitting the indication of UE data inactivity to the CU, receive, from the CU, a CU-to-DU message requesting a small data transmission (SDT) DU configuration for the UE; and
transmit the SDT DU configuration to the UE.

16. The DU of claim 15, wherein the DU is further configured to:
after transmitting the SDT DU configuration to the UE, communicate with the UE in accordance with the SDT DU configuration.

17. The DU of claim 15, wherein the CU-to-DU message is a first CU-to-DU message, and wherein the DU is further configured to:
in response to receiving the first CU-to-DU message, transmit a DU-to-CU message including the SDT DU configuration to the CU; and
receive, from the CU, a second CU-to-DU message including the SDT DU configuration and a SDT CU configuration,
wherein the DU configured to transmit the SDT DU configuration to the UE includes the DU being configured to transmit the SDT DU configuration and the SDT CU configuration to the UE.

18. The DU of claim 17, wherein the first CU-to-DU message is a UE context modification request message and the DU-to-CU message is a UE context modification response message.

19. The DU of claim 15, wherein the DU configured to determine that there is data inactivity for the UE includes the DU being configured to:
while communicating with the UE in accordance with the first DU configuration, monitor for data inactivity of the UE; and
detect data inactivity of the UE.

20. The DU of claim 19, wherein the DU is further configured to:
before monitoring for data inactivity of the UE, receive a message from the CU requesting that the DU perform the monitoring; and
receive an inactivity timer value from the CU,
wherein the DU configured to monitor for data inactivity of the UE includes the DU being configured to monitor for data inactivity of the UE in accordance with the inactivity timer value.
